(19) United States
(12) Patent Application Publication
(10) Pub. No.: US 2017/0205627 A1
(43) Pub. Date: Jul. 20, 2017

(54) IMAGE-FORMING OPTICAL SYSTEM, ILLUMINATION APPARATUS, AND OBSERVATION APPARATUS

(71) Applicant: OLYMPUS CORPORATION, Tokyo (JP)

(72) Inventor: Hiroya FUKUYAMA, Tokyo (JP)

(73) Assignee: OLYMPUS CORPORATION, Tokyo (JP)

(21) Appl. No.: 15/475,370

(22) Filed: Mar. 31, 2017

Related U.S. Application Data
(63) Continuation of application No. PCT/JP2015/078805, filed on Oct. 9, 2015.

(30) Foreign Application Priority Data
Oct. 9, 2014 (JP) 2014-208112

(51) Int. Cl. G02B 27/00; G02B 21/00; G02B 21/02; G02B 17/02; G02B 23/24

(52) U.S. Cl. CPC G02B 27/0025; G02B 17/023; G02B 23/2423; G02B 21/02; G02B 27/0068; G02B 21/0044

(57) ABSTRACT

In order to prevent a flaw or the like on an optical element from overlapping an intermediate image, an observation apparatus includes: a light source; an illumination optical system; an image-forming optical system for focusing light from an observation subject; and an image-capturing element (photo-detector) for acquiring an image, wherein the image-forming optical system includes: a plurality of image-forming lenses for forming a final image and one or more intermediate images; a first phase modulator placed at the observation subject side relative to one of the intermediate images and that imparts a spatial disturbance; and a second phase modulator that is placed at a position so that one or more intermediate images is located between the position and the first phase modulator, and that cancels the spatial disturbance, and the image-forming optical system has an property for maintaining conjugacy in image formation relationship between the first and second phase modulators.

### CROSS-REFERENCE TO RELATED APPLICATIONS

This application is a Continuation Application of International Application No. PCT/JP2015/078805 filed on Oct. 9, 2015, which claims priority to Japanese Application No. 2014-208112 filed on Oct. 9, 2014.

The contents of International Application No. PCT/JP2015/078805 and Japanese application No. 2014-208112 are hereby incorporated herein by reference in their entirety.

Technical Field

The present invention is applied to an apparatus for forming an image of an object by use of, for example, a laser beam, and relates to an image-forming optical system, an illumination apparatus, and an observation apparatus for enhancing image quality.

Background Art

There is a known method for moving a focal-point position in an object along the optical axis direction (on the Z-axis) by adjusting the optical-path length at an intermediate-image position (see, for example, Patent Literature 1 and Patent Literature 2).

### CITATION LIST

### Patent Literature

### {PTL 1}

Publication of Japanese Patent No. 4011704

### {PTL 2}

Japanese Translation of PCT International Application, Publication No. 2010-513968

### SUMMARY OF INVENTION

One aspect of the present invention is an image-forming optical system including: a plurality of image-forming lenses that form a final image and at least one intermediate image; a first phase modulator that is placed at an observation subject side relative to one of the intermediate images formed by the image-forming lenses and that imparts a spatial disturbance to a wavefront of light from the object; and a second phase modulator that is placed at a position so that at least one intermediate image is located between the position and the first phase modulator, and that cancels out the spatial disturbance imparted by the first phase modulator to the wavefront of the light from the object, wherein the image-forming optical system has an image formation property which maintains conjugacy in an image formation relationship between the first and second phase modulators. In this aspect, the structure for maintaining conjugacy in image formation relationship between the first and second phase modulators may be a conjugacy-maintaining optical system placed between the first and second phase modulator.

### BRIEF DESCRIPTION OF DRAWINGS

FIG. 1 is a schematic view showing a first embodiment of an image-forming optical system used for a microscope apparatus according to the present invention.

FIG. 2 is a schematic view for explaining the operation of the image-forming optical system in FIG. 1.

FIG. 3 is an enlarged view showing the section from the pupil position on the observation subject side to the wavefront-restoring device in FIG. 2.

FIG. 4 is a schematic view showing an image-forming optical system used for a conventional microscope apparatus.

FIG. 5 is a schematic view showing a structure in which pupil image formation with a field lens satisfies the sine condition.

FIG. 6 is another schematic view for explaining the image-forming optical system in FIG. 1.

FIG. 7 is a schematic view showing a second embodiment of an image-forming optical system used for a microscope apparatus according to the present invention.

FIG. 8 is a schematic view showing a third embodiment of an image-forming optical system used for a microscope apparatus according to the present invention.

FIG. 9 is a schematic view showing a fourth embodiment of an image-forming optical system used for a microscope apparatus according to the present invention.

FIG. 10 is a schematic view showing the structure of a first modification of the fourth embodiment of the image-forming optical system according to the present invention.

FIG. 11 is a schematic view showing the structure of a second modification of the fourth embodiment of the image-forming optical system according to the present invention.

FIG. 12 is schematic view showing an observation apparatus according to a first embodiment of the present invention.

FIG. 13 is a schematic view showing an observation apparatus according to a second embodiment of the present invention.

FIG. 14 is a schematic view showing an observation apparatus according to a third embodiment of the present invention.

FIG. 15 is a schematic view showing a modification of the observation apparatus in FIG. 7.

FIG. 16 is a schematic view showing a first modification of the observation apparatus in FIG. 8.

FIG. 17 is a schematic view showing a yet another modification of the observation apparatus in FIG. 16.

FIG. 18 is a schematic view showing a second modification of the observation apparatus in FIG. 15.

FIG. 19 is a schematic view showing a third modification of the observation apparatus in FIG. 15.

FIG. 20 is a perspective view showing cylindrical lenses serving as one example of phase modulators used for an image-forming optical system and an observation apparatus according to the present invention.

FIG. 21 is a schematic view for explaining the operation in a case where the cylindrical lenses in FIG. 20 are used.

FIG. 22 is a view for explaining the relationship between the amount of phase modulation and optical power on the basis of Gaussian optics used for the explanation of FIG. 21.

FIG. 23 is a perspective view showing binary diffraction gratings serving as another example of phase modulators used for an image-forming optical system and an observation apparatus according to the present invention.

FIG. 24 is a perspective view showing one-dimensional sine-wave diffraction gratings serving as another example of phase modulators used for an image-forming optical system and an observation apparatus according to the present invention.

FIG. 25 is a perspective view showing free curved surface lenses serving as another example of phase modulators used for an image-forming optical system and an observation apparatus according to the present invention.

FIG. 26 is a longitudinal sectional view showing cone lenses serving as another example of phase modulators used for an image-forming optical system and an observation apparatus according to the present invention.

FIG. 27 is a perspective view showing concentric binary diffraction gratings serving as another example of phase modulators used for an image-forming optical system and an observation apparatus according to the present invention.

FIG. 28 is a schematic view for explaining the behavior of a ray along the optical axis in a case where diffraction gratings are used as phase modulators.

FIG. 29 is a schematic view for explaining the behavior of an on-axis ray in a case where diffraction gratings are used as phase modulators.

FIG. 30 is a detailed view of a central part for explaining the operation of a diffraction grating functioning as a wavefront-disturbing device.

FIG. 31 is a detailed view of a central part for explaining the operation of a diffraction grating functioning as a wavefront-restoring device.

FIG. 32 is a longitudinal sectional view showing spherical aberration devices serving as another example of phase modulators used for an image-forming optical system and an observation apparatus according to the present invention.

FIG. 33 is a longitudinal sectional view showing irregularly-shaped devices serving as another example of phase modulators used for an image-forming optical system and an observation apparatus according to the present invention.

FIG. 34 is a schematic view showing a reflective phase modulator serving as another example of a phase modulator used for an image-forming optical system and an observation apparatus according to the present invention.

FIG. 35 is a longitudinal sectional view showing gradient-index devices serving as another example of phase modulators used for an image-forming optical system and an observation apparatus according to the present invention.

FIG. 36 is a view showing one example of a lens array in a case where an image-forming optical system according to the present invention is applied to an apparatus for microscopically displaying an enlarged view for examination for an endoscopic use.

FIG. 37 is a view showing one example of a lens array in a case where an image-forming optical system according to the present invention is applied to a microscope provided with an endoscopic small-diameter objective lens with an inner focus function.

### DESCRIPTION OF EMBODIMENTS

### First Embodiment

A first embodiment of an image-forming optical system 1 used for a microscope apparatus (observation apparatus) according to the present invention will now be described with reference to the drawings.

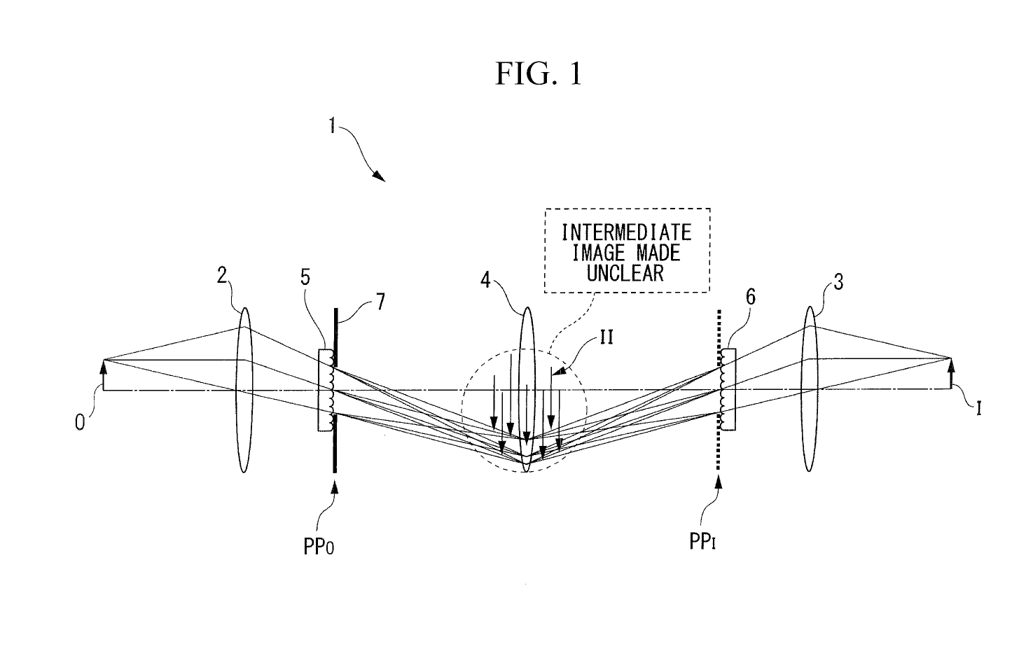

As shown in FIG. 1, the image-forming optical system 1 according to this embodiment includes: two image-forming lenses 2 and 3 constituting one pair arranged with a space therebetween; a field lens 4 placed on the intermediate-image-forming planes of these image-forming lenses 2 and 3; a wavefront-disturbing device (first phase modulator) 5 placed in the vicinity of a pupil position PP_{O} of the image-forming lens 2 on an object O side; and a wavefront-restoring device (second phase modulator) 6 placed in the vicinity of a pupil position PP_{I} of the image-forming lens 3 on an image I side. Reference sign 7 in the figure denotes an aperture stop.

When transmitting light that has been emitted from the object O and that has been focused by the image-forming lens 2 on the object O side, the wavefront-disturbing device 5 imparts a disturbance to the wavefront. As a result of the disturbance being imparted to the wavefront by the wavefront-disturbing device 5, the intermediate image formed on the field lens 4 is made unclear.

On the other hand, when transmitting the light that has been focused by the field lens 4, the wavefront-restoring device 6 imparts to the light a phase modulation that cancels out the disturbance on the wavefront imparted by the wavefront-disturbing device 5. The wavefront-restoring device 6 has opposite phase characteristics from those of the wavefront-disturbing device 5 and forms the clear final image I by canceling out the disturbance on the wavefront.

A more general concept of the image-forming optical system 1 according to this embodiment will be described below in detail.

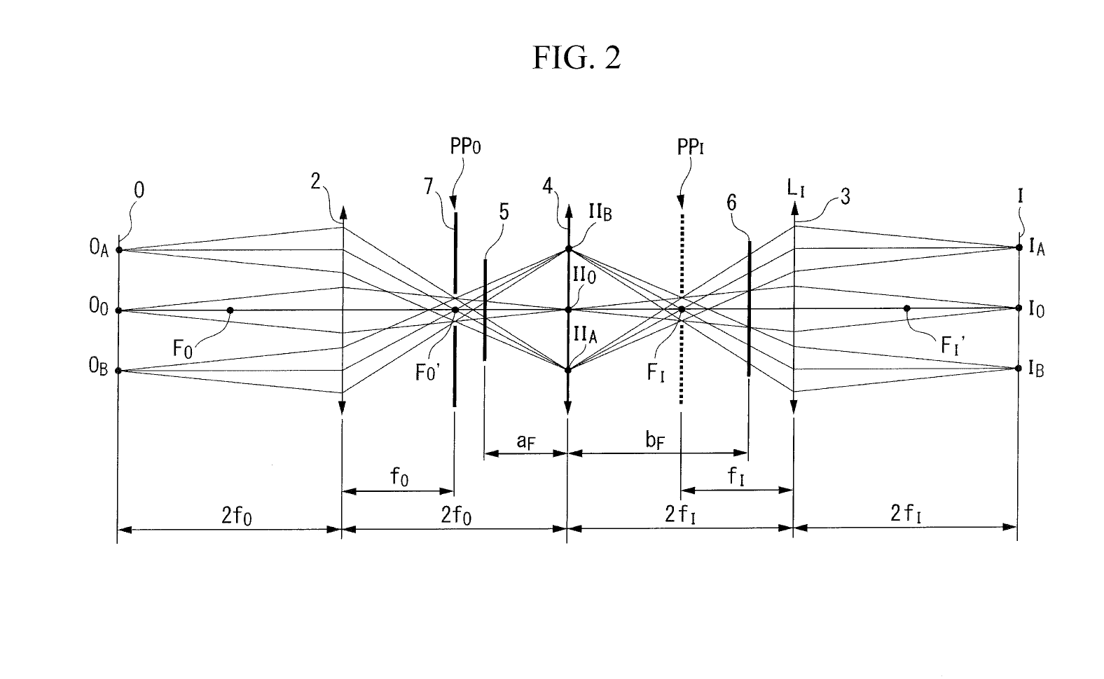

In the example shown in FIG. 2, the image-forming optical system 1 is arranged telecentrically with respect to the object O side and the image I side. Furthermore, the wavefront-disturbing device 5 is placed at a position which is distant by a distance a_{F} from the field lens 4 towards the object O side, and the wavefront-restoring device 6 is placed at a position which is distant by a distance b_{F} from the field lens 4 towards the image I side.

In FIG. 2, reference sign f₀ denotes the focal length of the image-forming lens 2, reference sign f_{I} denotes the focal length of the image-forming lens 3, reference signs F_{O} and F_{O}′ denote the focal positions of the image-forming lens 2, reference signs F_{I} and F_{I}′ denote the focal positions of the image-forming lens 3, and reference signs II_{O}, II_{A}, and II_{B} denote intermediate images.

Here, the wavefront-disturbing device 5 does not necessarily need to be placed in the vicinity of the pupil position PP_{O} of the image-forming lens 2, and the wavefront-restoring device 6 does not necessarily need to be placed in the vicinity of the pupil position PP_{I} of the image-forming lens 3.

On the other hand, it is necessary that the wavefront-disturbing device 5 and the wavefront-restoring device 6 be placed at mutually conjugate positions for image formation with the field lens 4, as indicated by Expression (1).

1/f_{F}=1/a_{F}+1/b_{F} (1)

Here, f_{F} is the focal length of the field lens 4.

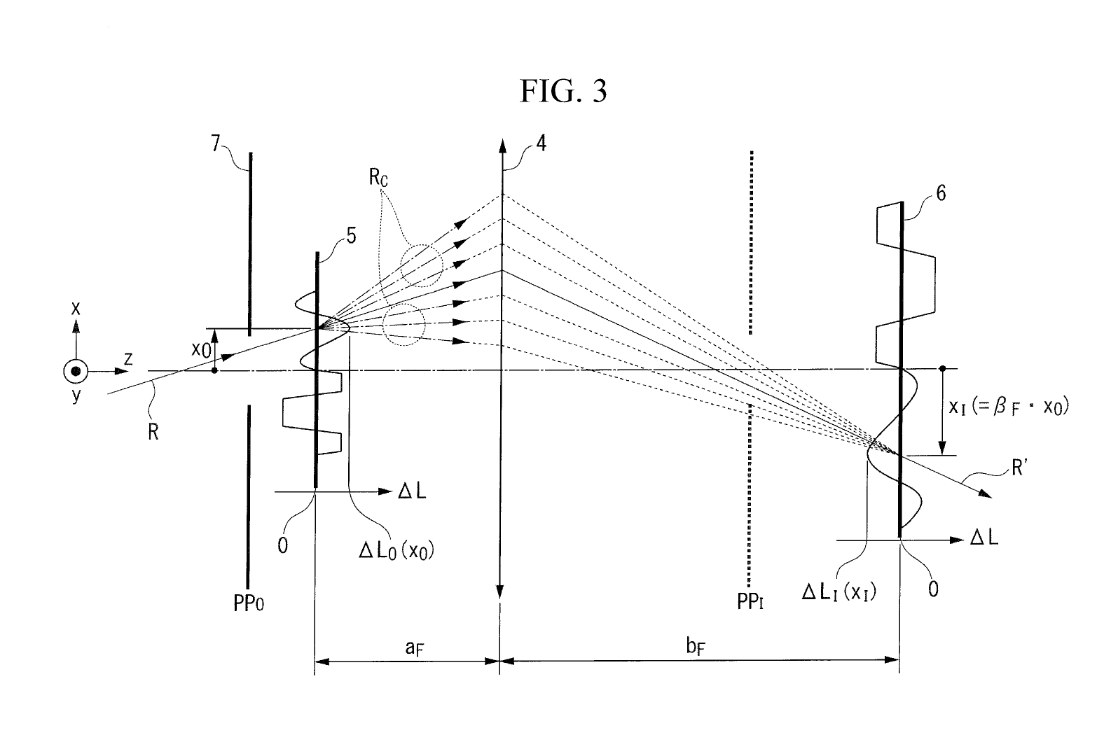

FIG. 3 is a view showing details of the section from the pupil position PP_{O} on the object O side to the wavefront-restoring device 6 in FIG. 2.

In the figure, ΔL is the amount of phase lead, relative to a ray passing through a particular position (i.e., ray height), that is imparted as a result of light passing through the optical elements.

Also, ΔL_{O}(x_{O}) is a function for providing the amount of phase lead of light that passes through an arbitrary ray height x_{O} at the wavefront-disturbing device 5, relative to the light that passes through the optical axis (x=0) at the wavefront-disturbing device 5.

Furthermore, ΔL_{I}(x_{I}) is a function for providing the amount of phase lead of light that passes through an arbitrary ray height xᵢ at the wavefront-restoring device 6, relative to the light that passes through the optical axis (x=0) at the wavefront-restoring device 6.

ΔL_{O}(x_{O}) and ΔL_{I}(x_{I}) satisfy Expression (2) below.

ΔL_{O}(x_{O})+ΔL_{I}(x_{I})=ΔL_{O}(x_{O})+ΔL_{I}(β_{F}·x_{O})=0 (2)

Here, β_{F} is the lateral magnification due to the field lens 4 in the conjugate relationship between the wavefront-disturbing device 5 and the wavefront-restoring device 6, and is represented by Expression (3) below.

β_{F}=−b_{F}/a_{F} (3)

When one ray R enters the image-forming optical system 1 as described above and passes through a position x_{O} at the wavefront-disturbing device 5, the ray is subjected to phase modulation of ΔL_{O}(x_{O}) at that position, producing a disturbed ray R_{C} due to refraction, diffraction, scattering, and so forth. The disturbed ray R_{C} is projected by the field lens 4 to a position x_{I}=β_{F}·x_{O} on the wavefront-restoring device 6 together with the components of the ray R that have not been subjected to phase modulation. As a result of passing through this position, the projected ray is subjected to phase modulation of ΔL_{I}(β_{I}·x_{O})=−ΔL_{O}(x_{O}), whereby the phase modulation applied by the wavefront-disturbing device 5 is cancelled out. By doing so, one ray R′ free of wavefront disturbance is restored.

If the wavefront-disturbing device 5 and the wavefront-restoring device 6 hold a conjugate positional relationship and have the characteristics represented by Expression (2), then it is assured that the ray that has been subjected to phase modulation via one position on the wavefront-disturbing device 5 passes through a particular position on the wavefront-restoring device 6, namely, the particular position that corresponds in a one-to-one manner to the one position and via which a phase modulation is imparted to cancel out the phase modulation applied by the wavefront-disturbing device 5. The optical systems shown in FIGS. 2 and 3 operate as described above in response to the ray R, regardless of the incidence position x_{O} or the incidence angle of the ray R on the wavefront-disturbing device 5. In short, the intermediate images II can be made unclear, and the final image I can be formed clearly in response to any ray R.

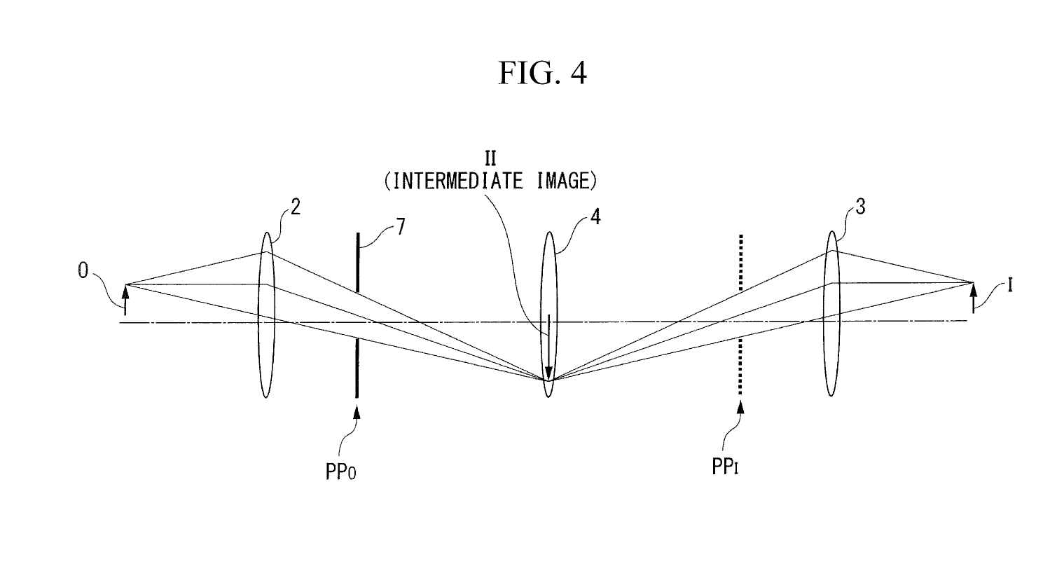

FIG. 4 shows a conventional image-forming optical system. According to this image-forming optical system, the light focused by the image-forming lens 2 on the object O side forms the clear intermediate images II on the field lens 4 placed on the intermediate-image forming plane and is then focused by the image-forming lens 3 on the image I side, thus forming the clear final image I.

The conventional image-forming optical system has a drawback in that if there is a flaw, dust, or the like on the surface of the field lens 4 or any defect, such as a hollow cavity, in the field lens 4, then the image of the foreign object overlaps an intermediate image clearly formed on the field lens 4, thereby forming the image of the foreign object on the final image I.

In contrast, according to the image-forming optical system 1 of this embodiment, because the intermediate images II that have been made unclear by the wavefront-disturbing device 5 are formed on the intermediate-image forming plane placed at the position corresponding to the field lens 4, the image of the foreign object overlapping the intermediate images II is made unclear due to a phase modulation by the wavefront-restoring device 6 when the unclear intermediate images II are made clear by the same phase modulation. Therefore, the image of the foreign object on the intermediate-image forming plane can be prevented from overlapping the clear final image I.

Here, in image formation, namely, pupil image formation with the field lens 4 that causes the wavefront-disturbing device 5 and the wavefront-restoring device 6 to have a conjugate relationship, a ray that causes the intermediate image to be greatly blurred (e.g., a high-order diffracted ray) has a large numerical aperture and produces a large aberration. When such a pupil aberration occurs, phase demodulation by the wavefront-restoring device 6 is impaired, failing to eliminate the blurred components in the final image.

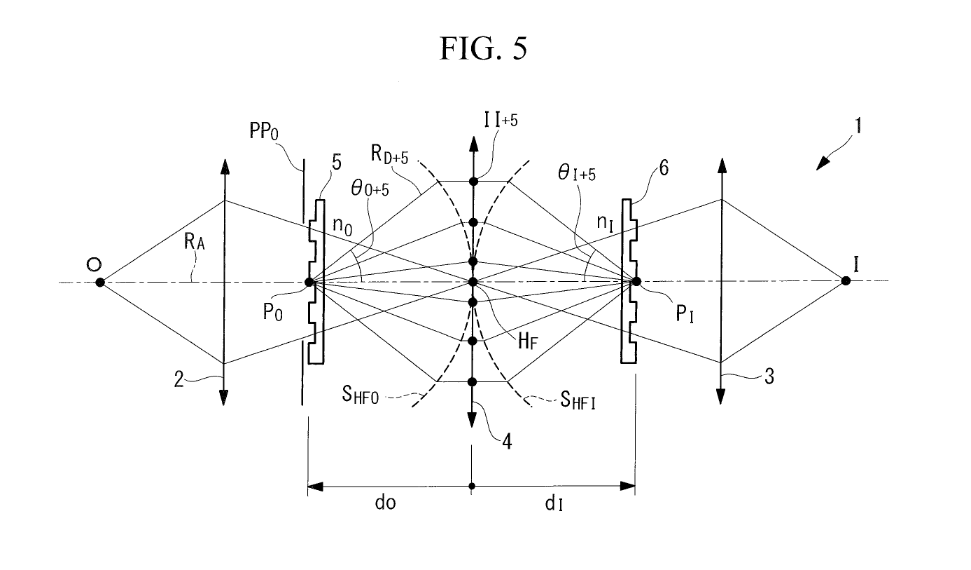

In contrast, if the lens placed between the wavefront-disturbing device 5 and the wavefront-restoring device 6 satisfies the sine condition in pupil image formation, the effect of aberration can be suppressed. For example, in the example shown in FIG. 5, if the following expression is satisfied in image formation with the field lens 4, the sine condition is satisfied, thereby suppressing the effect of pupil aberration. In the following descriptions, the wording “to satisfy the sine condition” does not necessarily mean to completely satisfy the sine condition, namely, to zero the OSC (offence against the sine condition). Rather, it is acceptable if pupil image formation is performed with a sufficient precision between the wavefront-disturbing device 5 and the wavefront-restoring device 6 in performing phase demodulation with the wavefront-restoring device 6.

sin Θ_{O(N)}/sin Θ_{I(N)}=(n_{I}/n_{O})×β_{F}

If n_{O}=n_{I}=1, sin Θ_{O(N)}/sin Θ_{I(N)}=β_{F}.

In FIG. 5, R_{D(N)}: (N)-order diffracted ray of a ray RA due to the wavefront-disturbing device 5 (e.g., R_{D+5} is a +5-order diffracted ray), Θ_{O(N)}: angle of the ray R_{D(N)} relative to the optical axis (the signs of Θ₀₊₁, Θ₀₊₃, and Θ₀₊₅ are negative), Θ_{I(N)}: angle of the ray R_{D(N)} refracted via the field lens 4 relative to the optical axis, H_{F}: principal point of the field lens 4, S_{HFO}: object-side principal surface of the field lens 4 (spherical surface whose center coincides with P_{O} and having a radius of |d_{O}|), S_{HFI}: image-side principal surface of the field lens 4 (spherical surface whose center coincides with P_{I} and having a radius of d_{I}), n_{O}: refractive index of the space medium towards the object O side from the field lens 4, and n_{I}: refractive index of the space medium towards the image I side from the field lens 4. Although FIG. 5 shows an example where up to ±5-order diffracted light occurs due to the wavefront-disturbing device 5, the sine condition can be satisfied and the effect of pupil aberration can be suppressed also in a case where higher-order diffracted light occurs, as long as the aforementioned expression is satisfied. Also in a case where diffracted light of lower order than 5 occurs, if the diffraction angle (Θ₀₍ₙ₎) is large enough to manifest a decrease in pupil image formation characteristics in the field lens 4 having an aberration like a spherical aberration, the sine condition is satisfied as long as the above expression holds, thereby making it possible to decrease the effect of pupil aberration. In addition, although FIG. 5 shows an example in which diffraction gratings are used for the wavefront-disturbing device 5 and the wavefront-restoring device 6, a case where refraction elements are used for the wavefront-disturbing device 5 and the wavefront-restoring device 6 leads to the same or a similar result.

In order to satisfy the above-described sine condition, it is preferable that the lens placed between the wavefront-disturbing device 5 and the wavefront-restoring device 6 has at least one aspherical surface or at least one concave surface.

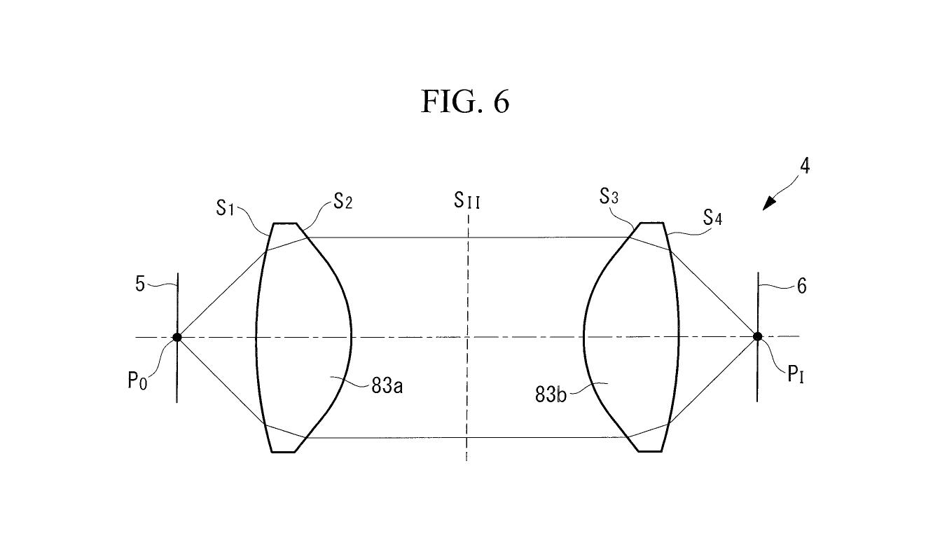

In this embodiment, a relay lens composed of a pair of aspheric lenses (conjugacy-maintaining optical systems) 83a and 83b for relaying light having passed through the wavefront modulation element 5 to the wavefront-restoring device 6 is used as the field lens 4, as shown in FIG. 6.

The object O-side surface of the aspheric lens 83a is composed of a spherical surface S₁, and the image I-side surface on the reverse side is composed of an aspherical surface S₂. On the other hand, the object O-side surface of the aspheric lens 83b is composed of an aspherical surface S₃, and the image I-side surface on the reverse side is composed of a spherical surface S₄.

According to the image-forming optical system 1 with the aforementioned structure, because at least one surface from among the four surfaces S1, S2, S3, and S4 constituting the aspheric lenses 83a and 83b (the surface S2 and the surface S3 in the example shown in FIG. 6) is an aspherical surface as shown in FIG. 6, the sine condition in image formation in relation to the object point P_{O} and the image point P_{I} can be satisfied, in other words, the OSC (offence against the sine condition) can be suppressed.

Because of this, a conjugate relationship in image formation between the wavefront-disturbing device 5 and wavefront-restoring device 6 is maintained, thereby not only forming the object point P_{O} as the image point P_{I} without aberration but also forming a point displaced from the object point P_{O} in a direction intersecting the optical axis as an image without aberration in a direction intersecting the optical axis for the image point P_{I}. Therefore, phase demodulation with the wavefront-restoring device 6 can be performed with high precision by suppressing spherical aberration and comatic aberration in image formation in relation to the object point P_{O} and the image point P_{I}, thus acquiring a clear final image.

Although in this embodiment, two surfaces (surface S2 and surface S3) of the aspheric lenses 83a and 83b are aspherical surfaces, it is sufficient if at least one surface from among the four surfaces (surfaces S1, S2, S3, and S4) is an aspherical surface.

### Second Embodiment

A second embodiment of the image-forming optical system 1 used for a microscope apparatus according to the present invention will now be described with reference to the drawings.

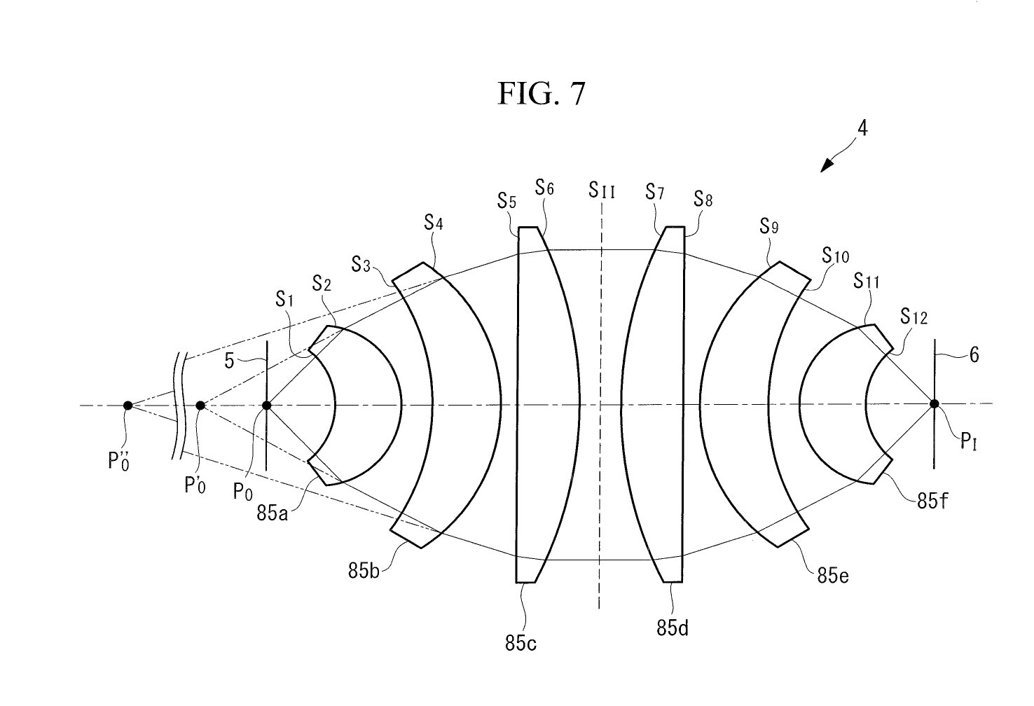

Part of the image-forming optical system 1 according to this embodiment differs from the first embodiment in that an aplanatic lens composed of six lenses (conjugacy-maintaining optical systems) 85a, 85b, 85c, 85d, 85e, and 85f is employed as the field lens 4, as shown in FIG. 7.

In the description of this embodiment, parts in common with the structures of the above-described image-forming optical system 1 according to the first embodiment are denoted with the same reference signs, and a description thereof will be omitted.

The lens 85a and the lens 85f, the lens 85b and the lens 85e, and the lens 85c and the lens 85d each have the same shape and are formed so as to be symmetric about the intermediate-image plane S_{II}.

The lens 85a is aplanatic, namely, aberration-free in relation to the object point P_{O} and the image P_{O}′. The lens 85b is aplanatic in relation to the object point P_{O}′ and the image P_{O}″. The lens 85c is not aplanatic for image formation (collimation) of the point P_{O}″ but has low refractive power necessary for collimation. Therefore, the aberration that occurs in the lens 85c is very small.

Because the lenses 85d, 85e, and 85f have the same shapes as, and are symmetric about the intermediate-image plane S_{II} to, the lenses 85a, 85b, and 85c, light that has passed through the lenses 85d, 85e, and 85f forms an image at the image point P_{I} with small aberration.

According to the image-forming optical system 1 of this embodiment, a clear final image can be acquired by suppressing spherical aberration and comatic aberration in image formation in relation to the object point P_{O} and the image point P_{I}.

### Third Embodiment

A third embodiment of the image-forming optical system 1 used for a microscope apparatus of the present invention will be described with reference to the drawings.

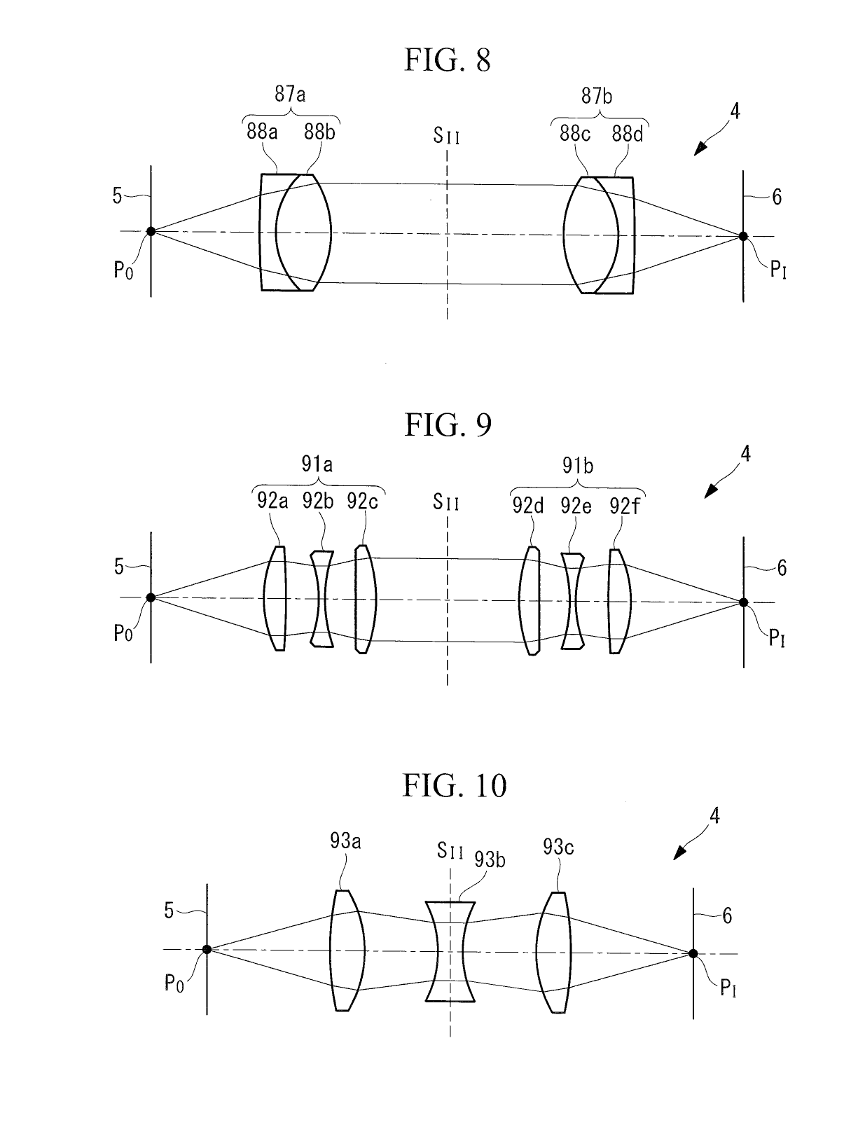

Part of the image-forming optical system 1 according to this embodiment includes, as the field lens 4, a first lens group (conjugacy-maintaining optical system) 87a for converting the light from the object O into collimated light and a second lens group (conjugacy-maintaining optical system) 87b for focusing the light converted into collimated light by the first lens group 87a, and differs from the first embodiment in that it is provided with two pairs of doublet lenses (Fraunhofer-type achromat), as shown in FIG. 8.

In the description of this embodiment, parts in common with the structures of the above-described image-forming optical system 1 according to the first embodiment are denoted with the same reference signs, and a description thereof will be omitted.

The first lens group 87a and the second lens group 87b have the same shape. More specifically, the first lens group 87a is composed of a combined lens formed of a flint glass concave meniscus lens 88a having the convex surface thereof oriented towards the object O side and a biconvex lens 88b made of crown glass. The second lens group 87b is composed of a combined lens formed of a biconvex lens 88c made of crown glass and a flint glass concave meniscus lens 88d having the convex surface thereof oriented towards the image I side. The lenses 88a and 88b of the first lens group 87a and the lenses 88c and 88d of the second lens group 87b are achromatic lenses.

According to the image-forming optical system 1 of this embodiment, the OSC (offence against the sine condition) is suppressed, thereby forming the object point P_{O} as the image point P_{I} without aberration. Therefore, a clear final image can be acquired by suppressing spherical aberration and comatic aberration in image formation in relation to the object point P_{O} and the image point P_{I}. Furthermore, the chromatic aberration can also be reduced by configuring the first lens group 87a and the second lens group 87b using an achromatic lens. Therefore, this embodiment is effective particularly in a case where light of interest has a plurality of wavelengths or a wavelength over a wide range.

### Fourth Embodiment

A fourth embodiment of the image-forming optical system 1 used for a microscope apparatus according to the present invention will be described with reference to the drawings.

Part of the image-forming optical system 1 according to this embodiment includes, as the field lens 4, a first lens group (conjugacy-maintaining optical system) 91a for converting the light from the object point P_{O} into collimated light and a second lens group (conjugacy-maintaining optical system) 91b for focusing the light converted into collimated light by the first lens group 91a, and differs from the first embodiment in that it is provided with two pairs of triplet lenses (Cook type), as shown in FIG. 9.

In the description of this embodiment, parts in common with the structures of the above-described image-forming optical system 1 according to the first embodiment are denoted with the same reference signs, and a description thereof will be omitted.

The first lens group 91a is composed of a biconvex lens 92a having the strongly convex surface thereof oriented towards the object O side, a biconcave lens 92b, and a plane-convex lens 92c having the convex surface thereof oriented towards the image I side. The second lens group 91b is composed of a plane-convex lens 92d having the convex surface thereof oriented towards the object O side, a biconcave lens 92e, and a biconvex lens 92f having the strongly convex surface thereof oriented towards the image I side. The first lens group 91a and the second lens group 91b are each an anastigmat lens.

According to the image-forming optical system 1 of this embodiment, the OSC (offence against the sine condition) is suppressed, thereby forming the object point P_{O} as the image point P_{I} without aberration. Therefore, not only spherical aberration and comatic aberration in image formation in relation to the object point P_{O} and the image point P_{I} can be reduced, but also five Seidel aberrations, including spherical aberration, comatic aberration, astigmatism, distortion aberration, and image plane curvature aberration, can be reduced with good balance.

This embodiment can be modified as follows.

Although two triplet lenses are used as the field lens 4 in this embodiment, a first modification may be such that the field lens 4 is realized by, for example, one triplet lens (Cook type) composed of a biconvex lens (conjugacy-maintaining optical system) 93a, a biconcave lens (conjugacy-maintaining optical system) 93b, and a biconvex lens (conjugacy-maintaining optical system) 93c, as shown in FIG. 10.

In this case, it may be possible that the lens group composed of the biconvex lens 93a, biconcave lens 93b, and biconvex lens 93c are configured so as to become an anastigmat lens. By doing so, the image of the object point P_{O} is formed at the image point Pi without aberration, thereby making it possible to decrease the above-described five Seidel aberrations with good balance.

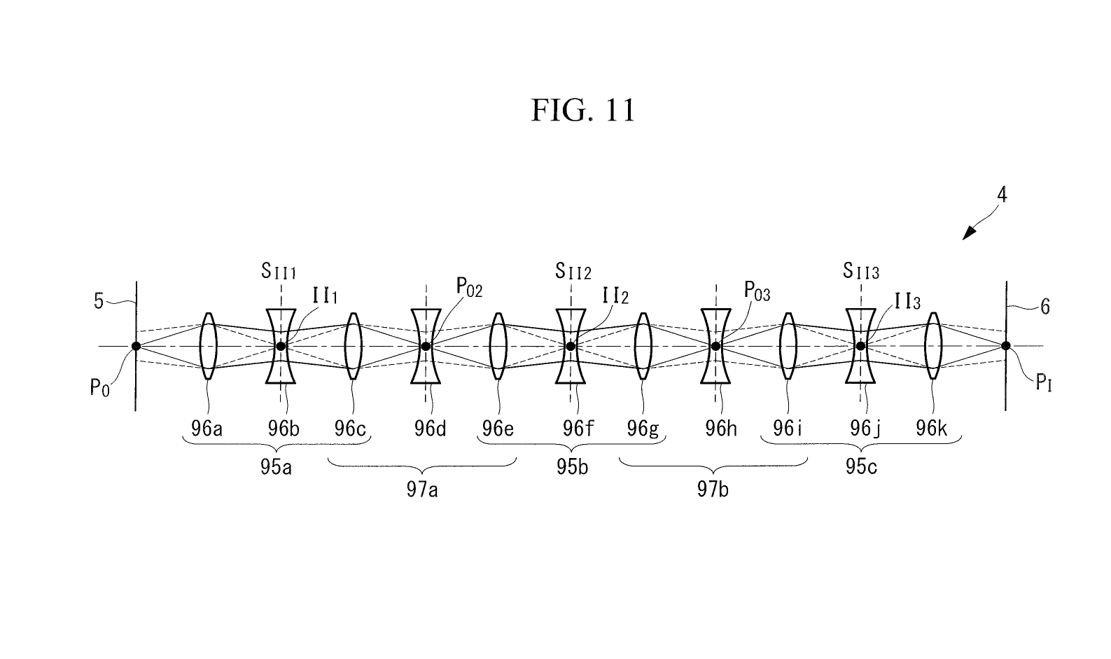

In a second modification, the field lens 4 may be realized by, for example: a first lens group (conjugacy-maintaining optical system) 95a, a second lens group (conjugacy-maintaining optical system) 95b, and a third lens group (conjugacy-maintaining optical system) 95c, each constituting a triplet lens; a biconcave lens 96d placed between the first lens group 95a and the second lens group 95b; and a biconcave lens 96h placed between the second lens group 95b and the third lens group 95c, as shown in FIG. 11.

The first lens group 95a is composed of a biconvex lens 96a, a biconcave lens 96b, and a biconvex lens 96c; the second lens group 95b is composed of a biconvex lens 96e, a biconcave lens 96f, and a biconvex lens 96g; and the third lens group 95c is composed of a biconvex lens 96i, a biconcave lens 96j, and a biconvex lens 96k. The first lens group 95a, the second lens group 95b and, the third lens group 95c are each an anastigmat lens.

In this case, the pupil image of the wavefront-disturbing device 5 placed on the pupil plane is formed three times repeatedly via the first lens group 95a, the second lens group 95b, and the third lens group 95c and is then projected onto the wavefront-restoring device 6 placed on the pupil conjugate plane.

At the same time, a lens group 97a, composed of the biconvex lens 96c of the first lens group 95a, the biconcave lens 96d, and the biconvex lens 96e of the second lens group 95b, and a lens group 97b, composed of the biconvex lens 96g of the second lens group 95b, the biconcave lens 96h, and the biconvex lens 96i of the third lens group 95c, each form an object image as a triplet lens so that intermediate-image planes S_{II1}, S_{II2}, and S_{II3} have a conjugate relationship. The lens groups 97a and 97b are an anastigmat lens. In FIG. 11, the solid lines indicate a pupil-image-formation ray, and the dashed lines indicate an object-image-formation ray.

According to the image-forming optical system 1 with this structure, as a result of both object image formation and pupil image formation being performed with the anastigmat lenses, the above-described five Seidel aberrations can be reduced with a good balance for both the object images and the pupil images.

Although the two image-forming lenses 2 and 3 have been described as being arranged telecentrically, they are not limited to this arrangement. The same effect can also be achieved with a non-telecentric system.

In addition, although the function for the amount of phase lead has been described as a one-dimensional function, the same effect can also be achieved with a two-dimensional function.

Furthermore, the spaces between the image-forming lens 2, the wavefront-disturbing device 5, and the field lens 4, as well as the spaces between the field lens 4, the wavefront-restoring device 6, and the image-forming lens 3, are not necessarily required. The spaces between these elements may be optically bonded.

Furthermore, although the image forming function and the pupil relaying function have been separately assigned to the lenses constituting the image-forming optical system 1, namely, the image-forming lenses 2 and 3 and the field lens 4, one lens may have both the image forming function and the pupil relaying function simultaneously in the actual image-forming optical system. Also in such a case, the wavefront-disturbing device 5 can impart a disturbance to the wavefront to make the intermediate images II unclear, and the wavefront-restoring device 6 can cancel out the disturbance on the wavefront to make the final image I clear, provided that the above-described conditions are satisfied.

An observation apparatus 10 according to a first embodiment of the present invention will now be described with reference to the drawings.

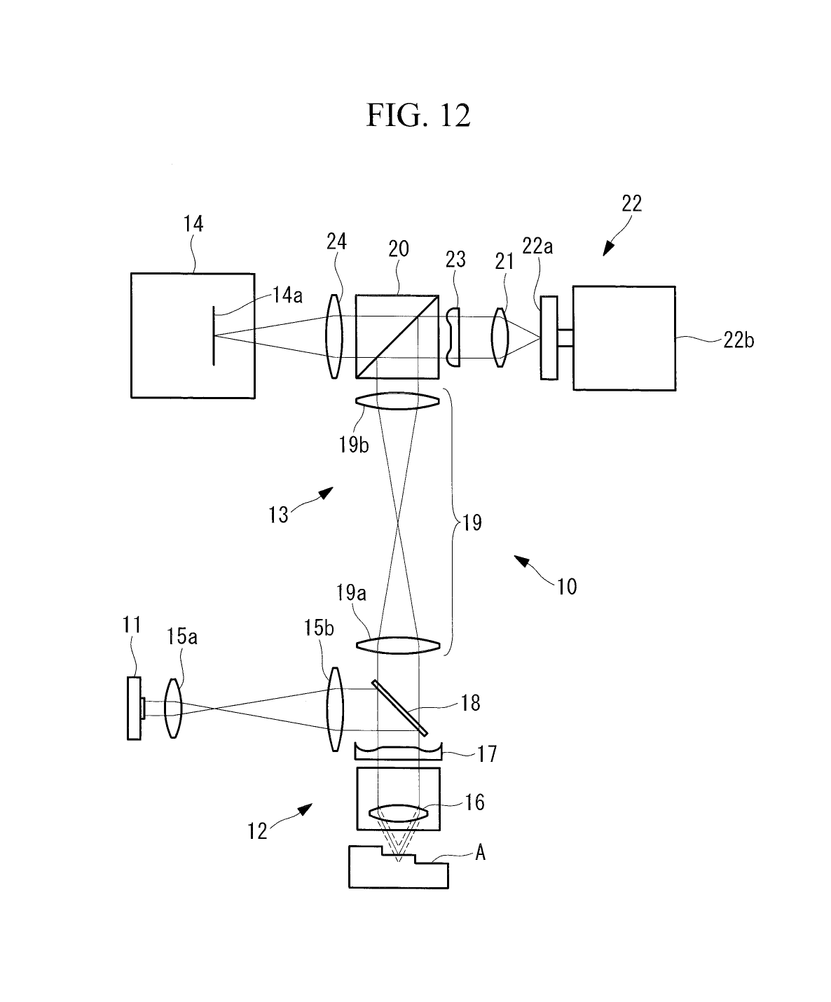

As shown in FIG. 12, the observation apparatus 10 according to this embodiment includes: a light source 11 for generating non-coherent illumination light; an illumination optical system 12 for irradiating an observation subject A with the illumination light from the light source 11; an image-forming optical system 13 for focusing the light from the observation subject A; and an image-capturing element (photo-detector) 14 for acquiring an image of the light focused by the image-forming optical system 13.

The illumination optical system 12 includes: focusing lenses 15a and 15b for focusing the illumination light from the light source 11; and an objective lens 16 for irradiating the observation subject A with the illumination light focused by the focusing lenses 15a and 15b.

Furthermore, this illumination optical system 12 is so-called Koehler illumination, and the focusing lenses 15a and 15b are arranged so that the light emission plane of the light source 11 and the pupil plane of the objective lens 16 are mutually conjugate.

The image-forming optical system 13 includes: the above-described objective lens (image-forming lens) 16 for collecting observation light (e.g., reflected light) emitted from the observation subject A placed on the observation subject side; a wavefront-disturbing device 17 for imparting a disturbance to the wavefront of the observation light collected by the objective lens 16; a first beam splitter 18 for splitting off the light the wavefront of which has been subjected to disturbance from the illumination light path continuing from the light source 11; a first pair of intermediate-image forming lenses 19 arranged with a space therebetween in the optical axis direction; a second beam splitter 20 that deflects by 90° the light having passed through each of lenses 19a and 19b of the first pair of intermediate-image forming lenses 19; a second intermediate-image forming lens 21 that focuses the light deflected by the second beam splitter 20 to form an intermediate image; optical-path-length changing means 22 placed on the intermediate-image forming plane due to the second intermediate-image forming lens 21; a wavefront-restoring device 23 placed between the second beam splitter 20 and the second intermediate-image forming lens 21; and an image-forming lens 24 that focuses the light passing through the wavefront-restoring device 23 and the second beam splitter 20 to form a final image.

The image-capturing element 14 is a two-dimensional image sensor, such as a CCD or a CMOS, is provided with an image-capturing plane 14a placed at the image-forming position of the final image due to the image-forming lens 24, and is capable of acquiring a two-dimensional image of the observation subject A by capturing the incident light.

The wavefront-disturbing device 17 is placed in the vicinity of the pupil position of the objective lens 16. The wavefront-disturbing device 17 is composed of an optically transparent material that can transmit light, and when transmitting light, it imparts, to the wavefront of the light, a phase modulation in accordance with the uneven shape on its surface. In this embodiment, it is configured to impart the necessary wavefront disturbance by transmitting the observation light from the observation subject A once.

Furthermore, the wavefront-restoring device 23 is placed in the vicinity of the pupil position of the second intermediate-image forming lens 21. The wavefront-restoring device 23 is also composed of an optically transparent material that can transmit light and is configured to, when transmitting light, impart to the light wavefront a phase modulation in accordance with the uneven shape on its surface. In this embodiment, the wavefront-restoring device 23 is configured to impart, to the wavefront of the observation light, a phase modulation that would cancel out the wavefront disturbance imparted by the wavefront-disturbing device 17 by transmitting the observation light deflected by the beam splitter 20 and the observation light reflected by the optical-path-length changing means 22, twice in a round trip.

The optical-path-length changing means 22, serving as an optical axis (Z-axis) scanning system, includes: a plane mirror 22a placed orthogonal to the optical axis; and an actuator 22b for displacing the plane mirror 22a in the optical axis direction. When the plane mirror 22a is displaced in the optical axis direction through the operation of the actuator 22b of the optical-path-length changing means 22, the optical-path length between the second intermediate-image forming lens 21 and the plane mirror 22a is changed, thereby causing a position in the observation subject A conjugate to the image-capturing plane 14a, namely, the focal-point position in front of the objective lens 16, to be changed in the optical axis direction.

In order to observe the observation subject A by the use of the observation apparatus 10 according to this embodiment with this structure, the illumination optical system 12 irradiates the observation subject A with the illumination light from the light source 11. The observation light emitted from the observation subject A is collected by the objective lens 16, passes through the wavefront-disturbing device 17 once, passes through the first beam splitter 18 and the intermediate-image forming optical system 19, and is then deflected by 90° at the second beam splitter 20. Then, the observation light passes through the wavefront-restoring device 23 and is then reflected at the plane mirror 22a of the optical-path-length changing means 22, and passes through the wavefront-restoring device 23 again. The final image, formed by the image-forming lens 24 via the beam splitter 20, is acquired by the image-capturing element 14.

When the actuator 22b of the optical-path-length changing means 22 is operated to move the plane mirror 22a in the optical axis direction, the optical-path length between the second intermediate-image forming lens 21 and the plane mirror 22a can be changed. By doing so, the focal-point position in front of the objective lens 16 can be moved in the optical axis direction for scanning. Then, a plurality of images focused at different positions in the depth direction of the observation subject A can be acquired by capturing an image of the observation light at different focal-point positions. Furthermore, an image with a large depth of field can be acquired by combining these images through arithmetic averaging and then applying high-band enhancement processing to them.

In this case, an intermediate image due to the second intermediate-image forming lens 21 is formed in the vicinity of the plane mirror 22a of the optical-path-length changing means 22, and this intermediate image is made unclear due to the wavefront disturbance, which was imparted through the wavefront-disturbing device 17 and has remained after being partially canceled out when the light passed through the wavefront-restoring device 23 a first time. Then, the observation light after forming the unclear intermediate image is focused by the second intermediate-image forming lens 21, and thereafter passes through the wavefront-restoring device 23 a second time, thereby causing the wavefront disturbance to be completely cancelled out.

Consequently, the observation apparatus 10 according to this embodiment affords an advantage in that, even if a foreign object, such as a flaw or dust, exists on the surface of the plane mirror 22a, the image of the foreign object can be prevented from overlapping the final image, thereby making it possible to acquire a clear image of the observation subject A.

Furthermore, in the same manner, if the focal-point position in the observation subject A is moved in the optical axis direction, the intermediate image formed by the first pair of intermediate-image forming lenses 19 also varies by a large distance in the optical axis direction, and even though the intermediate image overlaps the position of the first pair of intermediate-image forming lenses 19 as a result of this variation or some optical element exists in the variation area, the image of the foreign object can be prevented from being acquired in a manner whereby it overlaps the final image because the intermediate image is made unclear. In this embodiment, mounting the scanning system as described above ensures that no noise images occur even if light shifts in the Z-axis direction on any optical element placed in the image-forming optical system.

An observation apparatus 30 according to a second embodiment of the present invention will now be described with reference to the drawings.

In the description of this embodiment, parts in common with the structures of the above-described observation apparatus 10 according to the first embodiment are denoted with the same reference signs, and a description thereof will be omitted.

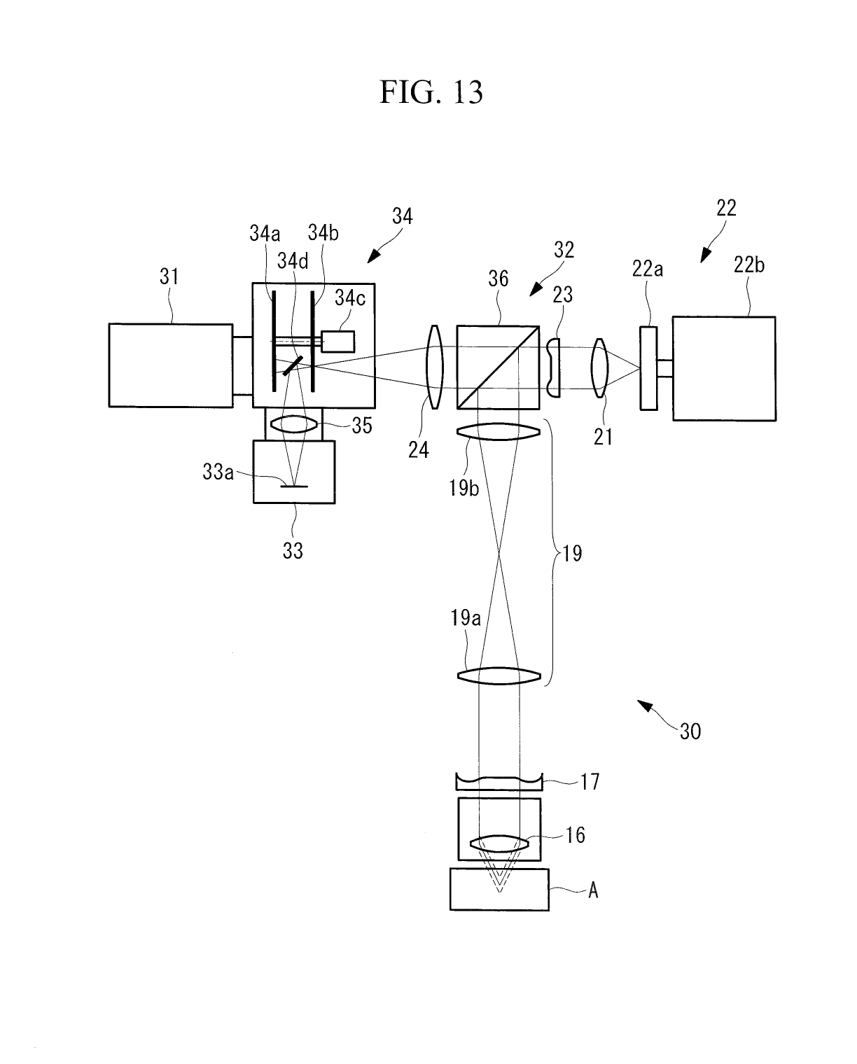

As shown in FIG. 13, the observation apparatus 30 according to this embodiment includes: a laser light source 31; an image-forming optical system 32 that focuses a laser beam from the laser light source 31 onto an observation subject A and that focuses the light from the observation subject A; an image-capturing element (photo-detector) 33 for acquiring an image of the light focused by the image-forming optical system 32; and a Nipkow disk confocal optical system 34 that is placed between the light source 31 and the image-capturing element 33 and the image-forming optical system 32. The laser light source 31 and the image-forming optical system 32 constitute an illumination apparatus.

The Nipkow disk confocal optical system 34 includes: two disks 34a and 34b arranged in parallel with a space therebetween; and an actuator 34c for simultaneously rotating those disks 34a and 34b. Many micro lenses (not shown in the figure) are arranged in the disk 34a on the laser light source 31 side, and many pinholes (not shown in the figure) are provided at positions corresponding to the micro lenses in the disk 34b on the observation subject side. Furthermore, a dichroic mirror 34d for splitting off the light having passed through the pinholes is fixed in a space between the two disks 34a and 34b. The light split off by the dichroic mirror 34d is focused by a focusing lens 35, and a final image is formed on an image-capturing plane 33a of the image-capturing element 33, thus acquiring an image.

In the image-forming optical system 32, the first beam splitter 18 and the second beam splitter 20 in the first embodiment are realized by a single beam splitter 36, thereby completely integrating the optical path for irradiating the observation subject A with the light passing through the pinholes of the Nipkow disk confocal optical system 34 and the optical path of the light that has been generated in the observation subject A and that is incident on the pinholes of the Nipkow disk confocal optical system 34.

The operation of the observation apparatus 30 according to this embodiment with this structure will be described below.

According to the observation apparatus 30 of this embodiment, light that is incident upon the image-forming optical system 32 from the pinholes of the Nipkow disk confocal optical system 34 passes through the beam splitter 36 and a phase modulator 23, is focused by a second intermediate-image forming lens 21, and is reflected at a plane mirror 22a of an optical-path-length changing means 22. After having passed through the second intermediate-image forming lens 21, the light passes through the phase modulator 23 again, is deflected by 90° by the beam splitter 36, and is focused onto the observation subject A by an objective lens 16 through a first pair of intermediate-image forming lenses 19 and a phase modulator 17.

In this embodiment, the phase modulator 23 through which a laser beam passes twice in the beginning functions as a wavefront-disturbing device for imparting a disturbance to the wavefront of the laser beam, and the phase modulator 17 through which the laser beam subsequently passes once functions as a wavefront-restoring device for imparting a phase modulation that cancels out the wavefront disturbance imparted by the phase modulator 23.

Therefore, when the light source image formed in the shape of many point light sources through the Nipkow disk confocal optical system 34 is formed by the second intermediate-image forming lens 21 as an intermediate image on the plane mirror 22a, it is possible to prevent the inconvenience that the image of a foreign object existing on the intermediate-image forming plane overlaps the final image, and this is because the intermediate image formed by the second intermediate-image forming lens 21 is made unclear by passing through the phase modulator 23 once.

Furthermore, because the disturbance imparted to the wavefront by passing through the phase modulator 23 twice is canceled out by passing through the phase modulator 17 once, it is possible to form a clear image of the many point light sources in the observation subject A. Then, high-speed scanning can be performed by rotating the disks 34a and 34b through the operation of the actuator 34c of the Nipkow disk confocal optical system 34 and moving the image of those many point light sources formed in the observation subject A in the XY directions intersecting the optical axis.

On the other hand, light, such as fluorescence, generated at the image-forming positions of the images of the point light sources in the observation subject A is collected by the objective lens 16 and passes through the phase modulator 17 and the first pair of the intermediate-image forming lenses 19. Then, the light is deflected by 90° by the beam splitter 36, passes through the phase modulator 23, is focused by the second intermediate-image forming lens 21, and is reflected in a folded manner at the plane mirror 22a. Thereafter, the light is focused again by the second intermediate-image forming lens 21 and passes through the phase modulator 23 and the beam splitter 36. Then, the light is focused by an image-forming lens 24 and is formed at the pinhole positions of the Nipkow disk confocal optical system 34.

The light having passed through the pinholes is split off from the optical path continuing from the laser light source by the dichroic mirror, is focused by the focusing lens, and is formed as a final image at the image-capturing plane of the image-capturing element.

In this case, the phase modulator 17 transmitting the fluorescence generated in the shape of many spots in the observation subject functions as a wavefront-disturbing device in the same manner as in the first embodiment, and the phase modulator 23 functions as a wavefront-restoring device.

Therefore, as for the fluorescence having a disturbance imparted to the wavefront thereof as a result of passing through the phase modulator 17, the disturbance is partially canceled out when the fluorescence passes through the phase modulator 23 once. Thus, the intermediate image formed on the plane mirror 22a is made unclear. Then, the fluorescence whose wavefront disturbance has been completely cancelled out by passing again through the phase modulator 23 forms an image at the pinholes of the Nipkow disk confocal optical system 34. Then, the fluorescence is split off by the dichroic mirror 34d after having passed through the pinholes, is focused by the focusing lens 35, and forms a clear final image at the image-capturing plane 33a of the image-capturing element 33.

Thus, according to the observation apparatus of this embodiment, in the form of not only an illumination apparatus for irradiating the observation subject A with a laser beam but also an observation apparatus for acquiring an image of fluorescence generated in the observation subject A, an advantage is afforded in that a clear final image can be acquired while still making the intermediate image unclear to prevent the image of a foreign object on the intermediate-image forming plane from overlapping the final image. In this embodiment, mounting the scanning system as described above ensures that no noise images occur even if light shifts in the Z-axis direction on any optical element placed in the image-forming optical system. In this embodiment, mounting the scanning system as described above ensures that no noise images occur even if light shifts in the Z-axis direction on any optical element placed in the image-forming optical system.

Next, an observation apparatus 40 according to a third embodiment of the present invention will be described with reference to the drawings.

In the description of this embodiment, parts in common with the structures of the above-described observation apparatus 30 according to the second embodiment are denoted with the same reference signs, and a description thereof will be omitted.

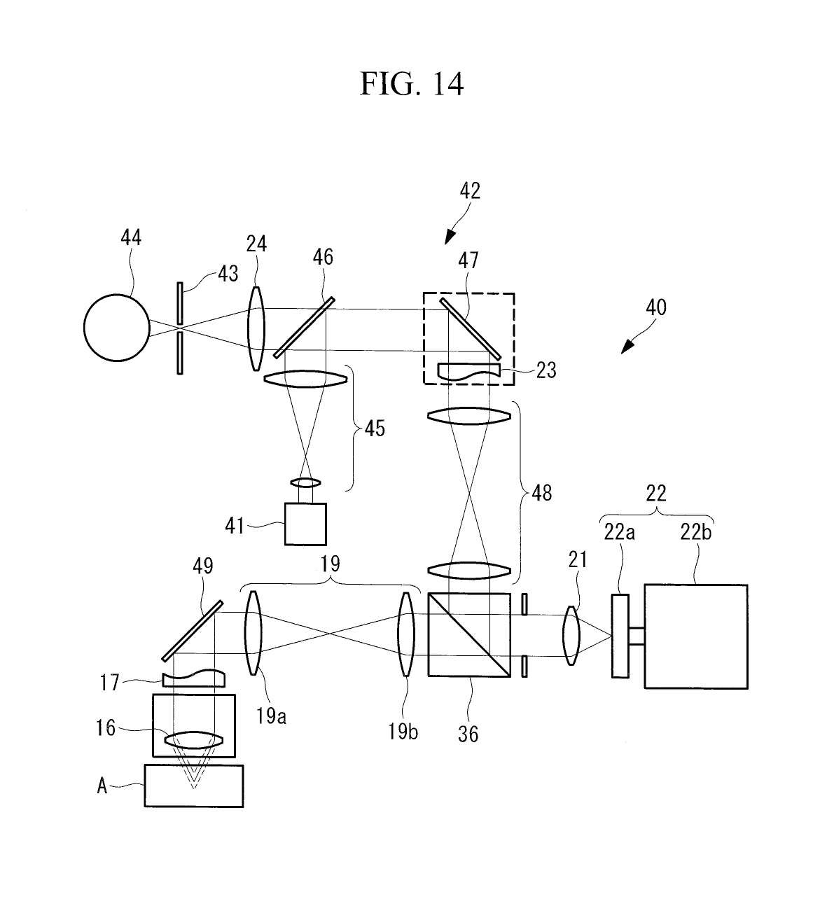

As shown in FIG. 14, the observation apparatus 40 according to this embodiment is a laser-scanning confocal observation apparatus.

This observation apparatus 40 includes: a laser light source 41; an image-forming optical system 42 that focuses a laser beam from the laser light source 41 onto an observation subject A and that focuses the light from the observation subject A; a confocal pinhole 43 transmitting the fluorescence focused by the image-forming optical system 42; and a photo-detector 44 for detecting the fluorescence having passed through the confocal pinhole 43.

The image-forming optical system 42 includes, as structures different from those of the observation apparatus 30 according to the second embodiment: a beam expander 45 for magnifying the beam diameter of a laser beam; a dichroic mirror 46 that deflects the laser beam and that transmits fluorescence; a galvanometer mirror 47 placed in the vicinity of a position conjugate to the pupil of an objective lens 16; and a third pair of intermediate-image forming lenses 48. In addition, a phase modulator 23 for imparting a disturbance to the wavefront of the laser beam is placed in the vicinity of the galvanometer mirror 47. Reference sign 49 in the figure denotes a mirror.

The operation of the observation apparatus 40 according to this embodiment with this structure will be described below.

According to the observation apparatus 40 of this embodiment, a laser beam emitted from the laser light source 41 is enlarged by the beam expander 45 in terms of the beam diameter, is deflected by the dichroic mirror 46, is scanned two-dimensionally by the galvanometer mirror 47, and is incident upon a beam splitter 36 through the phase modulator 23 and the third pair of intermediate-image forming lenses 48. The operation after being incident on the beam splitter 36 is the same as that of the observation apparatus 30 according to the second embodiment.

More specifically, because the laser beam forms an intermediate image on a plane mirror 22a of an optical-path-length changing means 22 after having a disturbance imparted to the wavefront thereof by the phase modulator 23, the intermediate image is made unclear, thereby preventing the overlapping of the image of a foreign object existing on the intermediate-image forming plane. Furthermore, because the wavefront disturbance is cancelled out by a phase modulator 17 placed at the pupil position of the objective lens 16, a final image that has been made clear can be formed in the observation subject A. In addition, the image formation depth of the final image can be adjusted freely by the optical-path-length changing means 22.

On the other hand, the fluorescence generated at the image-forming position of the final image of the laser beam in the observation subject A is collected by the objective lens 16 and passes through the phase modulator 17. Thereafter, the fluorescence travels along the opposite optical path of the laser beam and is deflected by the beam splitter 36. Then, the fluorescence is focused onto the confocal pinhole 43 by an image-forming lens 24 after having passed through the third pair of intermediate-image forming lenses 48, the phase modulator 23, the galvanometer mirror 47, and the dichroic mirror 46. Then, only the fluorescence having passed through the confocal pinhole 43 is detected by the photo-detector 44.

Also in this case, because the fluorescence collected by the objective lens 16 forms an intermediate image after having the disturbance imparted to the wavefront thereof by the phase modulator 17, the intermediate image is made unclear, thereby preventing overlapping of the image of a foreign object existing on the intermediate-image forming plane. Then, because the wavefront disturbance is cancelled out through the phase modulator 23, an image that has been made clear can be formed at the confocal pinhole 43, thereby making it possible to efficiently detect the fluorescence generated at the image-forming position of the final image of the laser beam in the observation subject A. As a result, an advantage is afforded in that a bright confocal image with high resolution can be acquired. In this embodiment, mounting the scanning system as described above ensures that no noise images occur even if light shifts in the Z-axis direction on any optical element placed in the image-forming optical system.

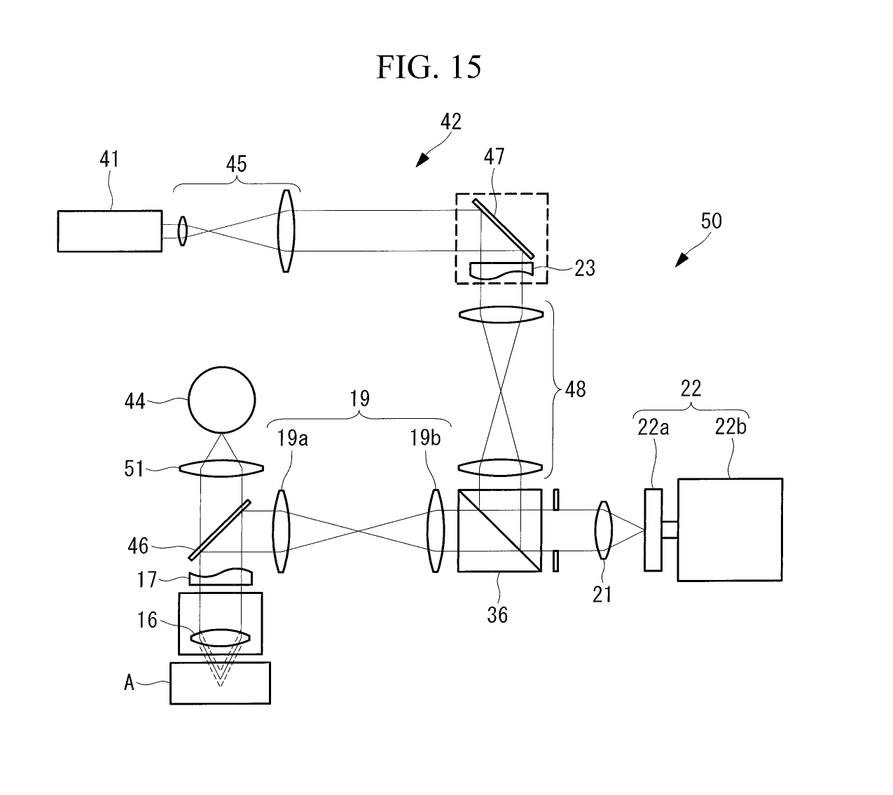

Although this embodiment has been described by way of an example of a laser-scanning confocal observation apparatus, it may instead be applied to a laser-scanning multiphoton-excitation observation apparatus, as shown in FIG. 15.

This can be achieved by employing an ultra-short pulsed laser beam source as the laser light source 41, removing the dichroic mirror 46, and employing the dichroic mirror 46 instead of the mirror 49.

In an observation apparatus 50 in FIG. 15, it is possible to make the intermediate image unclear and the final image clear by means of the function of the illumination apparatus for irradiating the observation subject A with an ultra-short pulsed laser beam. As for the fluorescence generated in the observation subject A, it is collected by the objective lens 16, is focused by a focusing lens 51 without forming an intermediate image after having passed through the phase modulator 17 and the dichroic mirror 46, and is detected as is by the photo-detector 44.

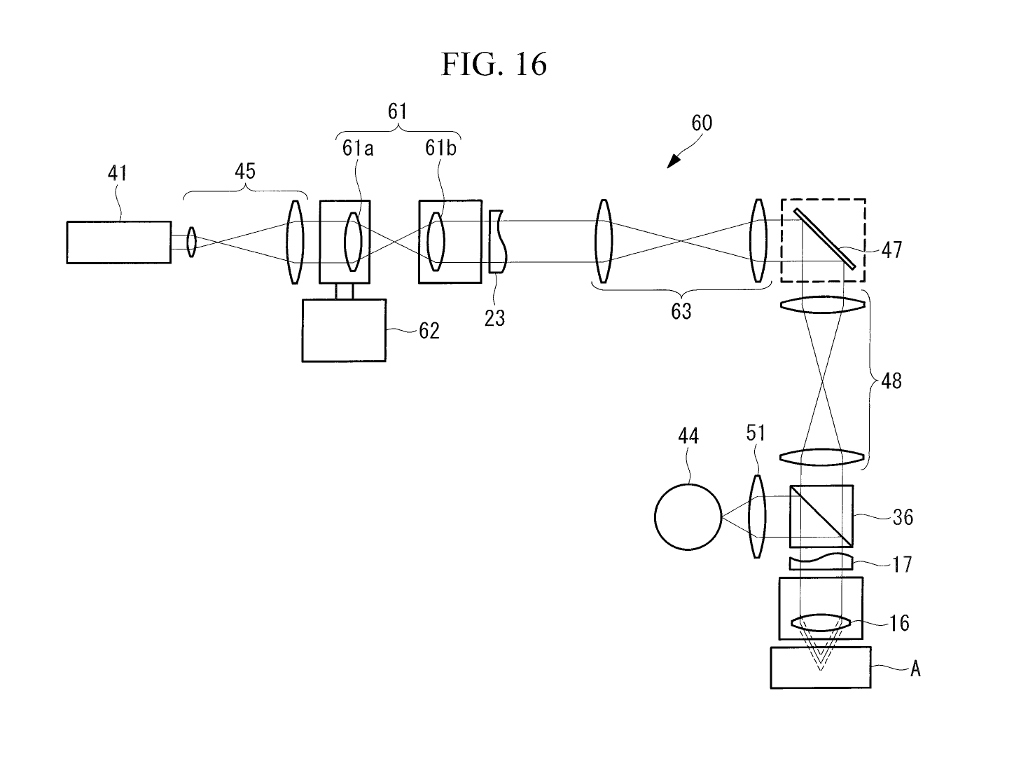

Furthermore, in each of the above-described embodiments, the focal-point position in front of the objective lens is changed in the optical axis direction with the use of the optical-path-length changing means 22 for changing the optical-path length by moving the plane mirror for folding back the optical path. Instead of this, a structure for changing the optical-path length by moving, with an actuator 62, one lens 61a of lenses 61a and 61b constituting an intermediate-image forming optical system 61 in the optical axis direction may be employed as the optical-path-length changing means, thus configuring an observation apparatus 60 as shown in FIG. 16. Reference sign 63 in the figure denotes another intermediate-image forming optical system.

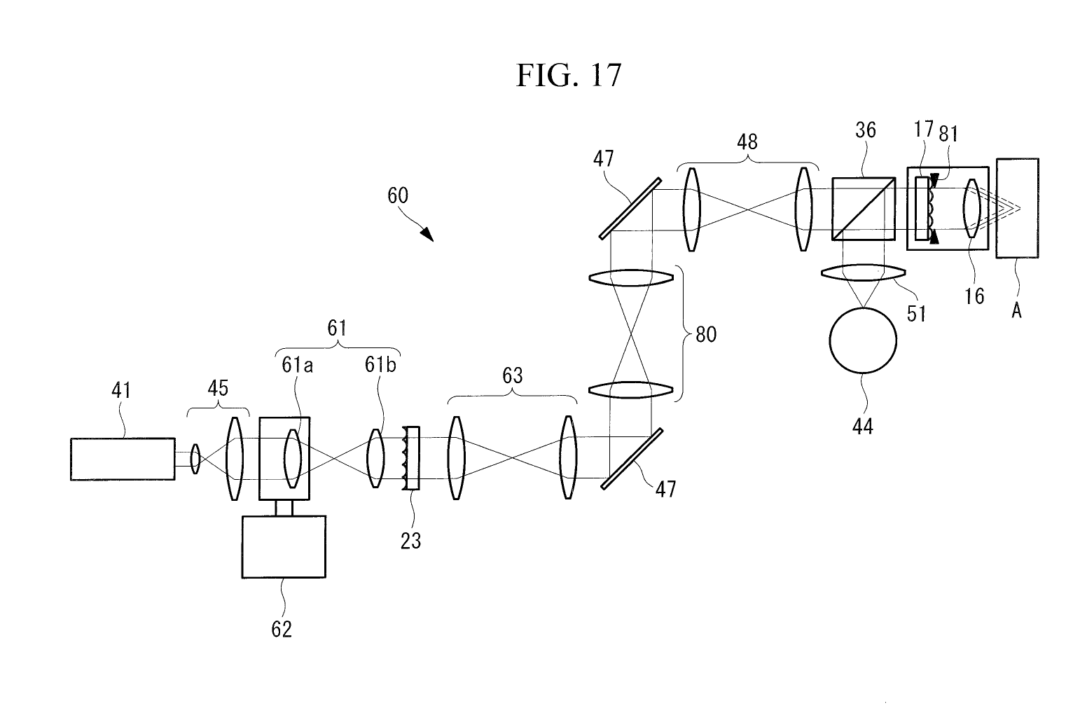

In an alternative structure, as shown in FIG. 17, another intermediate-image forming optical system 80 may be placed between two galvanometer mirrors 47 constituting a two-dimensional optical scanner, such that the two galvanometer mirrors 47 are accurately arranged at optically conjugate positions to the phase modulators 17 and 23, as well as to an aperture stop 81 placed at the pupil of the objective lens 16.

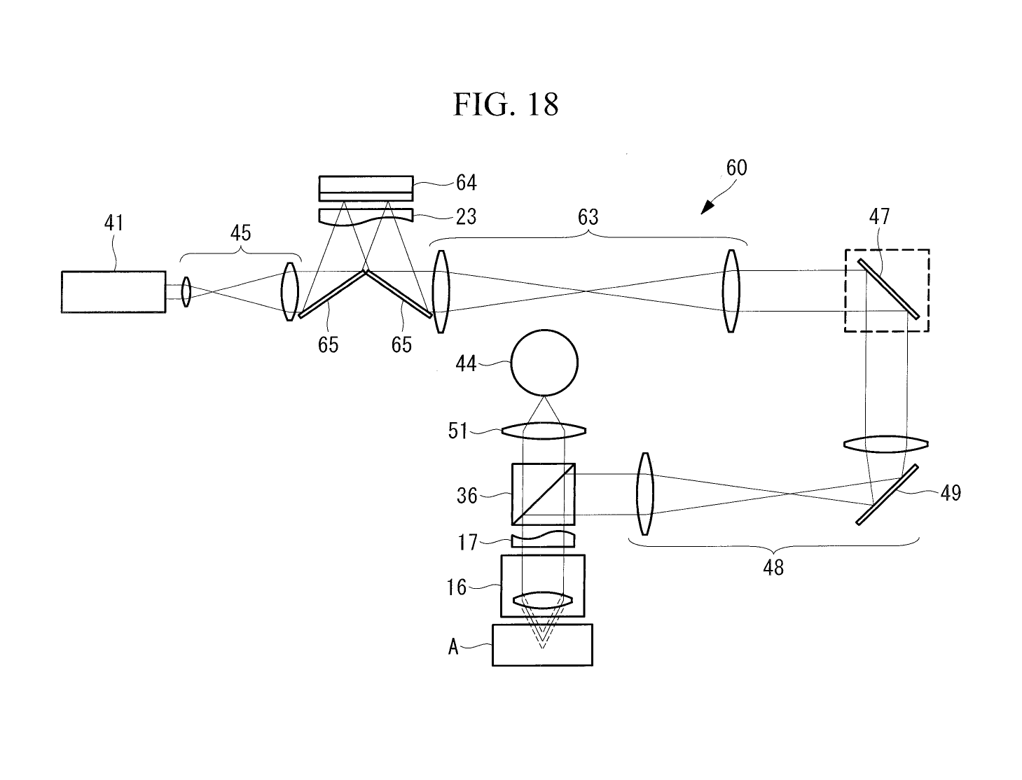

Alternatively, a spatial light modulation element (SLM) 64, like a reflective LCOS, may be employed as the optical-path-length changing means, as shown in FIG. 18. In this manner, the focal-point position in front of the objective lens 16 can be changed at high speed in the optical axis direction by rapidly changing the phase modulation to be imparted to the wavefront through control of the liquid crystal of the LCOS. Reference sign 65 in the figure denotes a mirror.

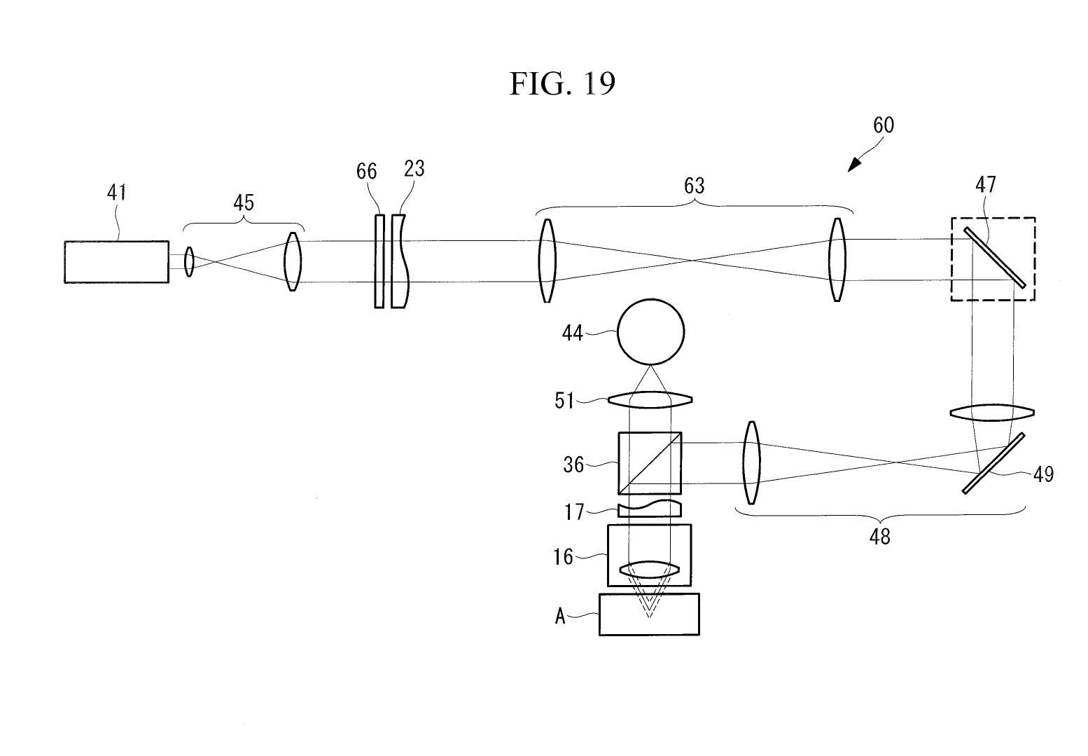

Alternatively, instead of the spatial light modulation element 64 like a reflective LCOS, a spatial light modulation element 66 like a transmissive LCOS may be employed, as shown in FIG. 19. The structure can be made simpler than that of the reflective LCOS because the mirror 65 is not necessary.

As means for moving the focal-point position in the observation subject A in the optical axis direction, various types of well-known variable-power optical elements can be used as active optical elements in addition to those described in each of the above-described embodiments (optical-path-length changing means 22, intermediate-image forming optical system 61 and actuator 62, reflective spatial light modulation element 64, or transmissive spatial light modulation element 66). First, elements having a mechanically movable part include a shape-variable mirror (DFM: Deformable Mirror) and a shape-variable lens using liquid or gel. Similar elements not having a mechanically movable part include a liquid crystal lens or a potassium tantalate niobate (KTN: KTa₁₋ₓNbₓO₃) crystal lens, which controls the refractive index of the medium by means of an electric field, and a lens in which the cylindrical lens effect in an acousto-optic deflector (AOD/Acousto-Optical Deflector) is applied.

For the observation apparatus of the present invention, in the observation apparatuses 10, 20, and 30 according to the above-described embodiments, the above-described image-forming optical system 1 is applied in place of the image-forming optical systems 13, 32, and 42. By applying the image-forming optical system 1 in the observation apparatuses 10, 20, and 30, the blurred components imparted by a phase modulation can be reliably canceled out by a phase demodulation with the effect of a pupil aberration being suppressed, thus making it possible to acquire a clear final image.

All the above-described embodiments in the form of a microscope according to the present invention have some means for moving the focal-point position in the observation subject A in the optical axis direction. Furthermore, compared with means for the same purpose (for moving either the objective lens or the observation subject in the optical axis direction) in conventional microscopes, these means for shifting the focal-point position in the optical-axis direction can dramatically increase the moving speed because the mass of the object to be driven is small or because a physical phenomenon with quick response is used. This affords an advantage in that it is possible to detect a higher-speed phenomenon in an observation subject (e.g., living biological tissue specimen).

Furthermore, in a case where the spatial light modulation elements 64 and 66, like a transmissive or reflective LCOS, are employed, it is possible to make the spatial light modulation elements 64 and 66 carry out the function of the phase modulator 23. This affords an advantage in that the phase modulator 23 serving as a wavefront-disturbing device can be omitted, thereby making the structure even simpler.

In the above-described example, the phase modulator 23 has been omitted in a combination of a spatial light modulation element and a laser-scanning multiphoton-excitation observation apparatus. In the same manner, the phase modulator 23 can also be omitted in a combination of a spatial light modulation element and a laser-scanning confocal observation apparatus. More specifically, in FIGS. 18 and 19, the dichroic prism 36 is replaced with the mirror 49; a branch optical path is formed by employing the dichroic mirror 46 between the beam expander 45 and the spatial light modulation elements 64 and 66; and the image-forming lens 24, the confocal pinhole 43, and the photo-detector 44 are employed, thereby making it possible to cause the spatial light modulation elements 64 and 66 to carry out the function of the phase modulator 23. The spatial light modulation elements 64 and 66 in this case operate as wavefront-disturbing devices that impart a disturbance to the wavefront in response to a laser beam from the laser light source 41, whereas they operate as a wavefront-restoring device for canceling out the wavefront disturbance imparted by the phase modulator 17 in response to the fluorescence from the observation subject A.

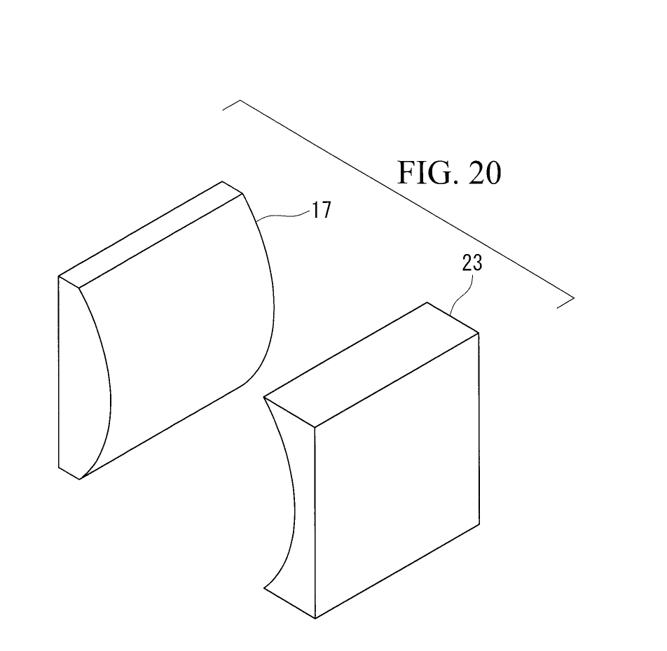

For the phase modulator, cylindrical lenses 17 and 23, for example, may be employed, as shown in FIG. 20.

In this case, the cylindrical lens 17 causes the intermediate image in the form of a point image to be elongated in a line shape by the effect of astigmatism, thereby making the intermediate image unclear. Then, the final image can be made clear by the use of the cylindrical lens 23 of the shape complementary to that of the cylindrical lens 17.

In the case of FIG. 20, either a convex lens or a concave lens may be used as a wavefront-disturbing device and as a wavefront-restoring device.

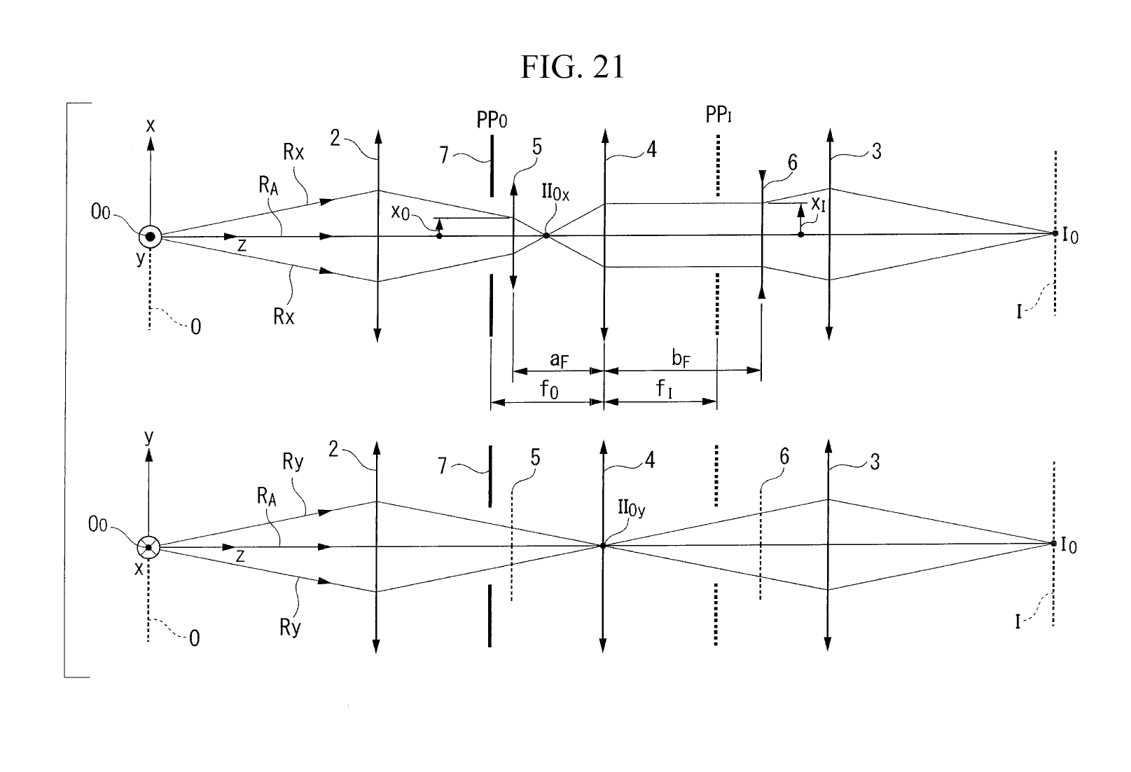

The operation in a case where cylindrical lenses 5 and 6 are used as phase modulators will be described in detail below. FIG. 21 illustrates the cylindrical lenses 5 and 6 in a case where they are used as the phase modulators in FIGS. 2 and 3.

In this example, the following conditions are set in particular.

(a) A cylindrical lens having refractive power ψ_{Ox} in the x direction is used as the phase modulator (wavefront-disturbing device) 5 on the object O side.

(b) A cylindrical lens having refractive power ψ_{Ix} in the x direction is used as the phase modulator (wavefront-restoring device) 6 on the image I side.

(c) Let the position (height of the ray), in the cylindrical lens 5, of an on-axis ray Rₓ on the xz plane be x_{O}.

(d) Let the position (height of the ray), in the cylindrical lens 6, of the on-axis ray Rₓ on the xz plane be X_{I}.

In FIG. 21, reference signs II_{0X} and II_{0Y} denote intermediate images.

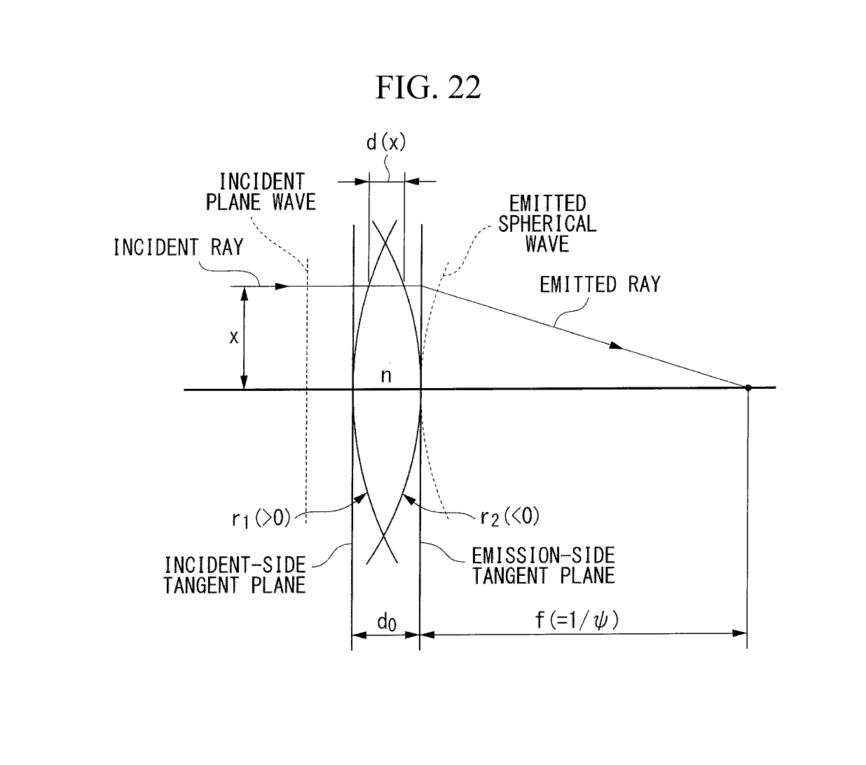

Before the operation in this example is described, the relationship between the phase modulation level and optical power based on the Gaussian optics will be described with reference to FIG. 22.

Assuming that the thickness of the lens at the height (distance from the optical axis) x is d(x) and that the thickness of the lens at the height 0 (on the optical axis) is d₀ in FIG. 22, the optical-path length L(x) from the incident-side tangent plane to the emission-side tangent plane, along the ray at the height x, is represented by Expression (4) below.

L(x)=(d₀−d(x))+n·d(x) (4)

The difference between the optical-path length L(x) at the height x and the optical-path length L(0) at the height 0 (on the optical axis) is represented by Expression (5) below using the thin lens approximation.

L(x)−L(0)=(−x²/2)(n−1)(1/r₁−1/r₂) (5)

The above-described difference L(x)−L(0) in optical-path length has the same absolute value as, and opposite sign of, the amount of phase lead of emitted light at the height x relative to the emitted light at the height 0. Therefore, the above-described amount of phase lead is represented by Expression (6) below, in which the sign in Expression (5) is reversed.

L(0)−L(x)=(x²/2)(n−1)(1/r₁−1/r₂) (6)

On the other hand, the optical power ψ of this thin lens is represented by Expression (7) below.

ψ=1/f=(n−1)(1/r₁−1/r₂) (7)

Therefore, on the basis of Expressions (6) and (7), the relationship between the amount of phase lead L(0)−L(x) and the optical power ψ is calculated from Expression (8) below.

L(0)−L(x)=ψ·x²/2 (8)

Now, the description with reference to FIG. 21 will resume.

The amount of phase lead ΔL_{Oc} exerted on the on-axis ray Rₓ on the xz plane in the cylindrical lens 5, relative to the on-axis chief ray, namely, ray R_{A} along the optical axis is represented by Expression (9) below on the basis of Expression (8).

ΔL_{Oc}(x_{O})=L_{Oc}(0)−L_{Oc}(x_{O})=ψ_{Ox}·x_{O}²/2 (9)

Here, L_{Oc}(x_{O}) is a function for the optical-path length from the incident-side tangent plane to the emission-side tangent plane, along the ray of height x_{O} in the cylindrical lens 5.

In the same manner, the amount of phase lead ΔL_{Ic} exerted on the on-axis ray Rx on the xz plane in the cylindrical lens 6, relative to the on-axis chief ray, namely, ray R_{A} along the optical axis, is represented by Expression (10) below.

ΔL_{Ic}(x_{I})=L_{Ic}(0)−L_{Ic}(x_{I})=ψ_{Ix}·x_{I}²/2 (10)

Here, L_{Ic}(x_{I}) is a function for the optical-path length from the incident-side tangent plane to the emission-side tangent plane, along the ray of height x_{I} in the cylindrical lens 6.

By applying Expressions (9) and (10), as well as the relationship (x_{I}/x_{O})²=β_{F}², to Expression (2) shown above, the conditions required for the cylindrical lens 5 to function for wavefront disturbance and for the cylindrical lens 6 to function for wavefront restoration in this example are obtained as shown in Expression (11).

ψ_{Ox}/ψ_{Ix}=−β_{F}² (11)

More specifically, the ψ_{Ox} value and the ψ_{Ix} value need to have opposite signs from each other, and the ratio between those absolute values needs to be proportional to the square of the lateral magnification of the field lens 4.

Here, although the description has been given on the basis of the on-axis ray, the cylindrical lenses 5 and 6 also function to disturb and restore the wavefront of an off-axis ray in the same manner, as long as they satisfy the above-described conditions.

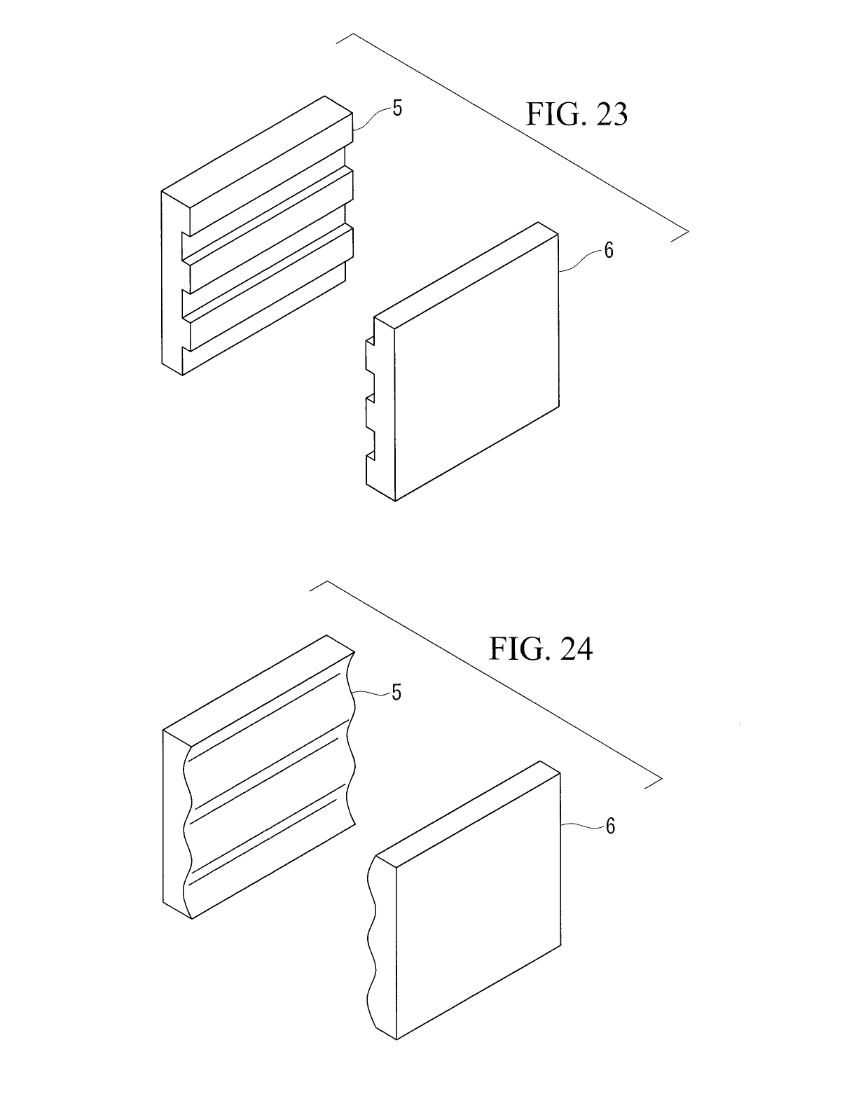

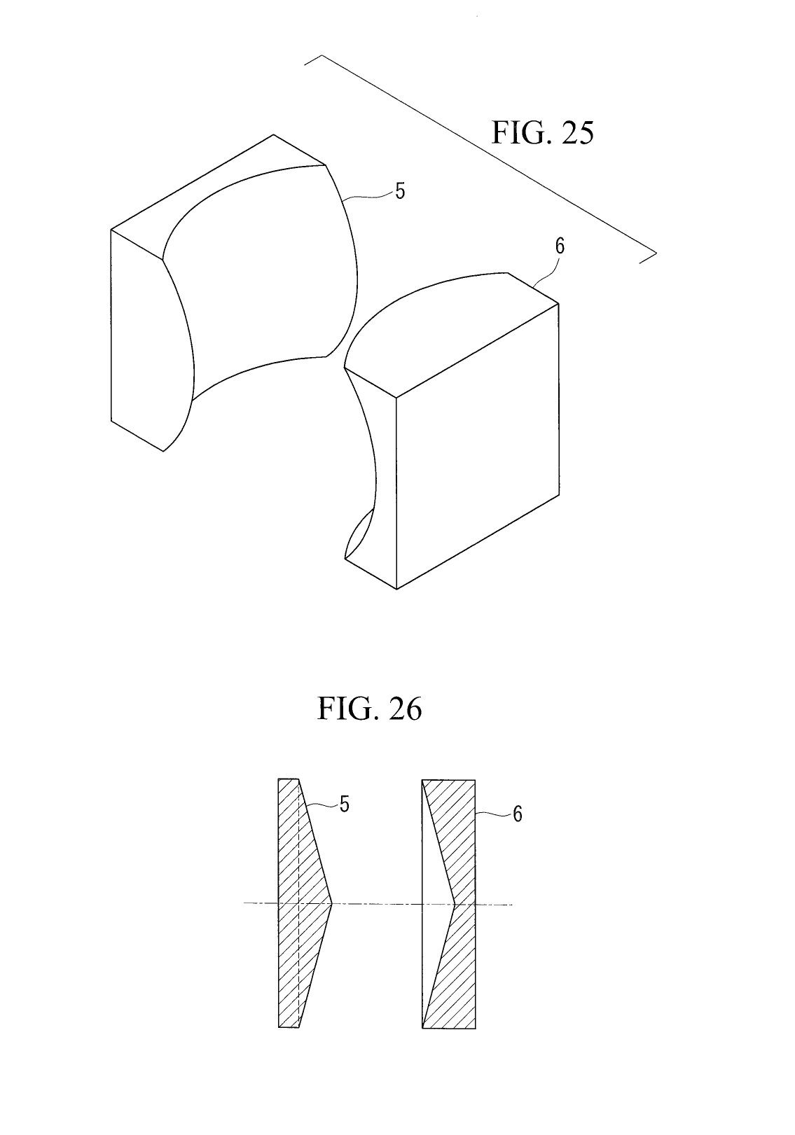

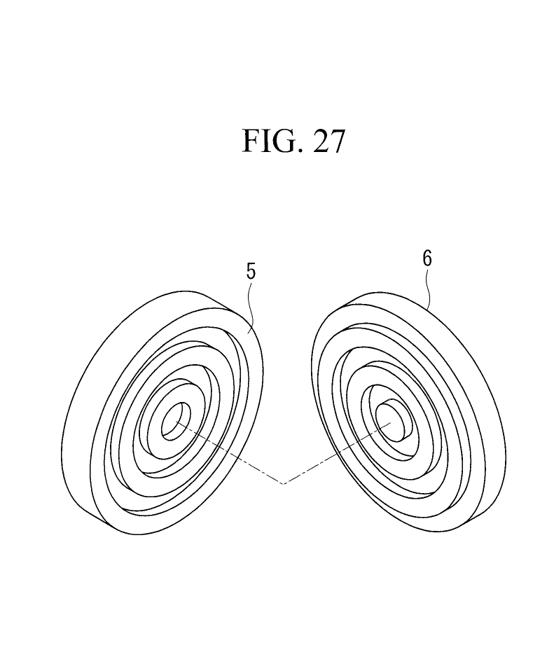

Furthermore, one-dimensional binary diffraction gratings as shown in FIG. 23, one-dimensional sine-wave diffraction gratings as shown in FIG. 24, free curved surface lenses as shown in FIG. 25, cone lenses as shown in FIG. 26, or concentric binary diffraction gratings as shown in FIG. 27 may be employed, instead of a cylindrical lens, for the phase modulators 5, 6, 17, and 23 (indicated as the phase modulators 5 and 6 in the figure). Concentric diffraction gratings are not limited to the binary type, but any type, including the blazed type and the sine wave type, can be employed.

Diffraction gratings 5 and 6 used as wavefront modulation elements will now be described in detail.

In the intermediate images II in this case, one point image is split into a plurality of point images through diffraction.

Through this operation, the intermediate images II are made unclear, thereby preventing the image of a foreign object on the intermediate-image forming plane from overlapping the final image.

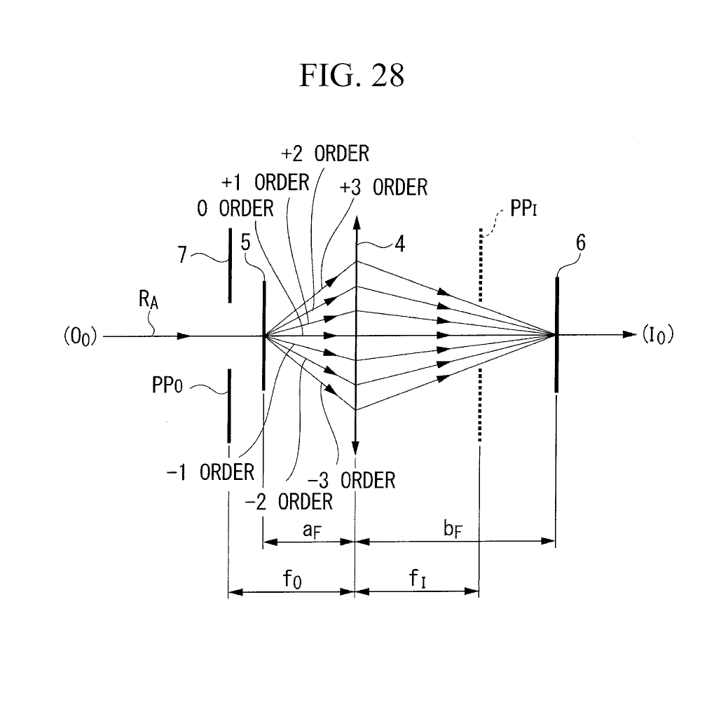

In a case where the diffraction gratings 5 and 6 are used as phase modulators, one example of a preferable pathway of the on-axis chief ray, namely, the ray R_{A} along the optical axis is shown in FIG. 28, and one example of a preferable pathway of an on-axis ray R_{X} is shown in FIG. 21. In these figures, each of the rays R_{A} and R_{X} is split into a plurality of diffracted light beams via the diffraction grating 5 and returns to the original one ray via the diffraction grating 6.

Also in this case, the above-described effect can be achieved by satisfying Expressions (1) through (3) above.

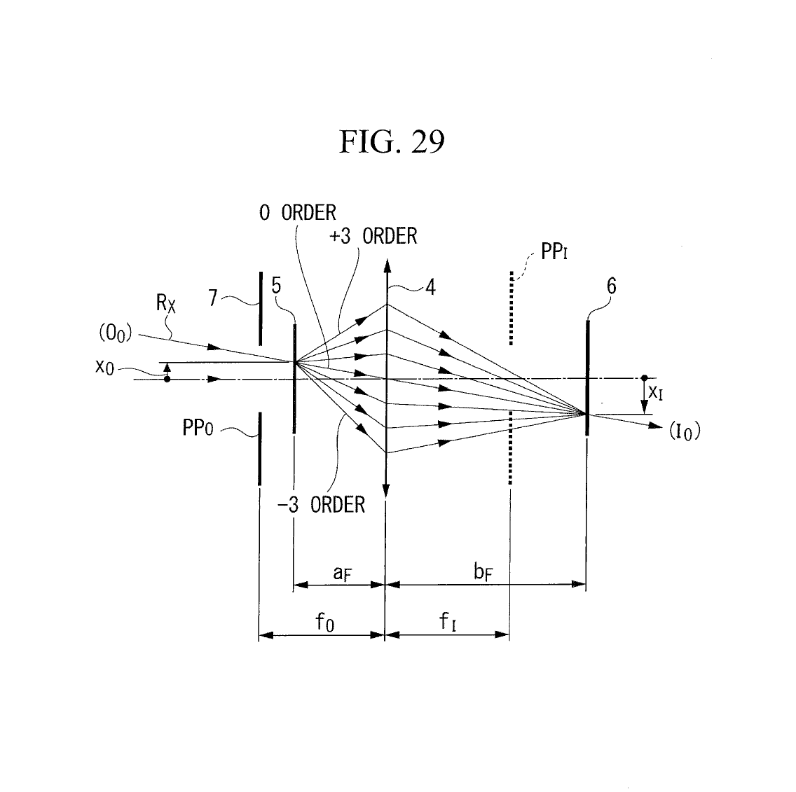

Here, in accordance with FIGS. 28 and 29, Expression (2) can be rephrased as “the sum of phase modulation exerted on one on-axis ray R_{X} at the diffraction gratings 5 and 6 is always equal to the sum of phase modulation exerted on the on-axis chief ray R_{A} at the diffraction gratings 5 and 6.”

Furthermore, in a case where the diffraction gratings 5 and 6 have a periodic structure, if their shapes (i.e., phase modulation characteristics) satisfy Expression (2) in an area equivalent to one period, they can also be regarded as satisfying Expression (2) in other areas.

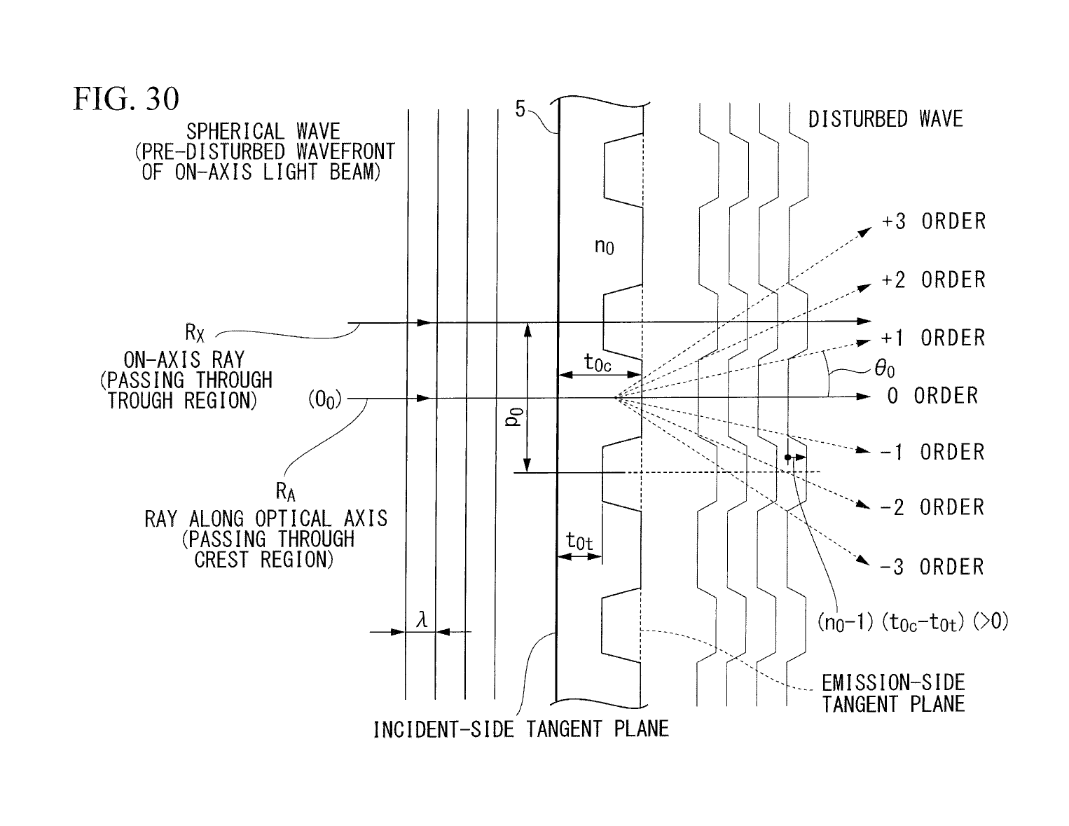

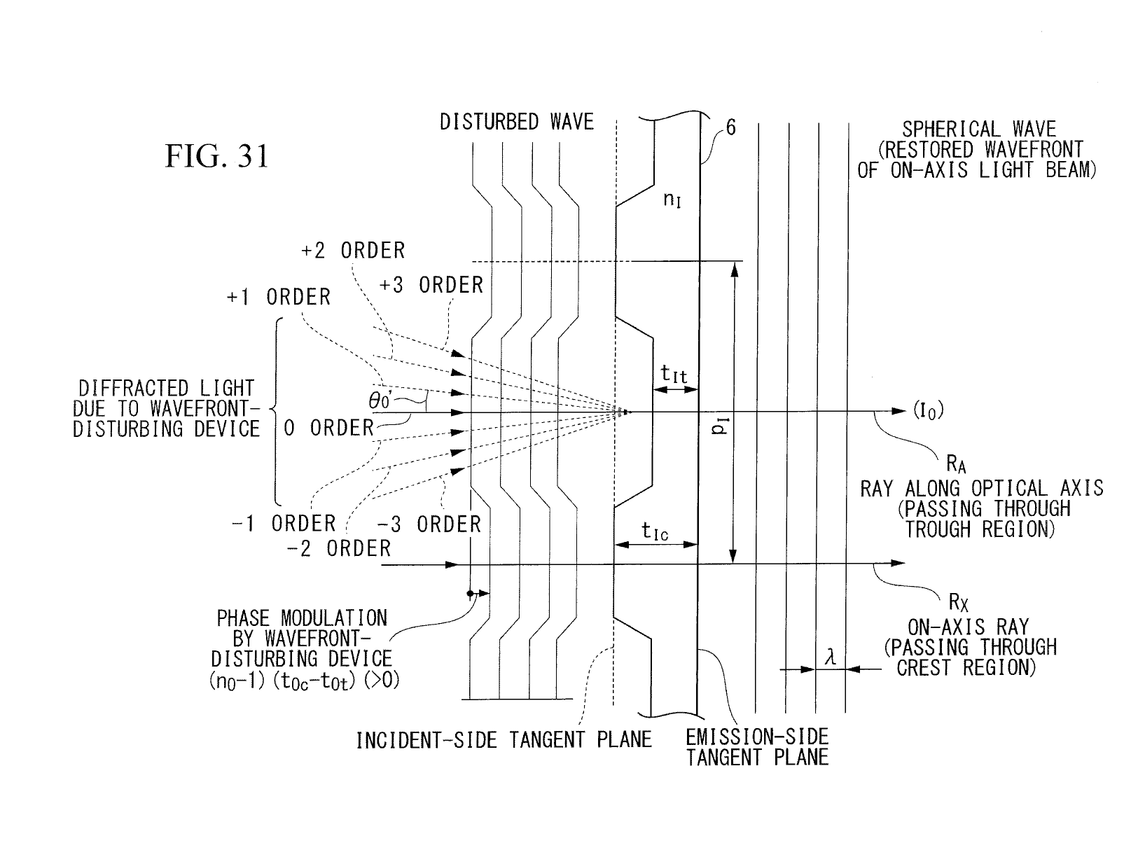

Hence, descriptions will be given with attention focused on the center portion, namely an area in the vicinity of the optical axis, of the diffraction gratings 5 and 6. FIGS. 30 and 31 are detailed views of the center portions of the diffraction grating 5 and the diffraction grating 6, respectively.

In this case, conditions required for the diffraction gratings 5 and 6 to satisfy Expression (2) are as follows.

More specifically, the period p_{I} of modulation in the diffraction grating 6 needs to be equal to the period p_{O} of modulation due to the diffraction grating 5 as projected via the field lens 4. In addition, the phase of modulation due to the diffraction grating 6 needs to be opposite to the phase of modulation due to the diffraction grating 5, as projected by the field lens 4, and also, the magnitude of phase modulation due to the diffraction grating 6 needs to be equal to the magnitude of the phase modulation due to the diffraction grating 6 in terms of absolute value.

First, the condition for the period p_{I} and the projected period p_{O} to be equal is represented by Expression (12).

p_{I}=|β_{F}|·p_{O} (12)

Next, in order that the phase of modulation due to the diffraction grating 6 is opposite to the phase of projected modulation due to the diffraction grating 5, not only does the diffraction grating 5 need to be placed, for example, so that one of the centers in its crest regions coincides with the optical axis, but also the diffraction grating 6 needs to be placed so that one of the centers in its trough regions coincides with the optical axis, in addition to the above-described Expression (12) being satisfied. FIGS. 30 and 31 are just one example of them.

Lastly, conditions for the magnitude of phase modulation due to the diffraction grating 6 and the magnitude of phase modulation due to the diffraction grating 5 to be equal in terms of absolute value are examined.

From optical parameters (crest region thickness t_{Oc}, trough region thickness t_{Ot}, and refractive index n_{O}) of the diffraction grating 5, the amount of phase lead ΔL_{Odt} exerted on the on-axis ray R_{X} passing through a trough region of the diffraction grating 5, relative to the ray R_{A} (passing through a crest region) along the optical axis, is represented by Expression (13) below.

ΔL_{Odt}=n_{O}·t_{Oc}−(n_{O}·t_{Ot}+(t_{Oc}−t_{Ot}))=(n_{O}−1)(t_{Oc}−t_{Ot}) (13)

In the same manner, from optical parameters (crest region thickness t_{Ic}, trough region thickness t_{It}, and refractive index n_{I}) of the diffraction grating 6, the amount of phase lead ΔL_{Idt} exerted on the on-axis ray R_{X} passing through a crest region of the diffraction grating 6, relative to the ray R_{A} (passing through a trough region) along the optical axis, is represented by Expression (14) below.

ΔL_{Idt}=(n_{I}·t_{It}+(t_{Ic}−t_{It}))−n_{I}·t_{Ic}=−(n_{I}−1)(t_{Ic}−t_{It}) (14)

In this case, because the value of ΔL_{Odt} is positive and the value of ΔL_{Idt} is negative, conditions for the absolute values of both the values to be equal are represented by Expression (15) below.

ΔL_{Odt}+ΔL_{Id}t=(n_{O}−1)(t_{Oc}−t_{Ot})−(n_{I}−1)(t_{Ic}−t_{It})=0 (15)

Here, although the descriptions have been given on the basis of the on-axis ray, the diffraction grating 5 functions for wavefront disturbance, and the diffraction grating 6 functions for wavefront restoration, as long as they satisfy the above-described conditions.

Furthermore, although the cross-sectional shape of the diffraction gratings 5 and 6 has been assumed to be a pedestal shape in this example, it is needless to say that other shapes can also exhibit the same function.

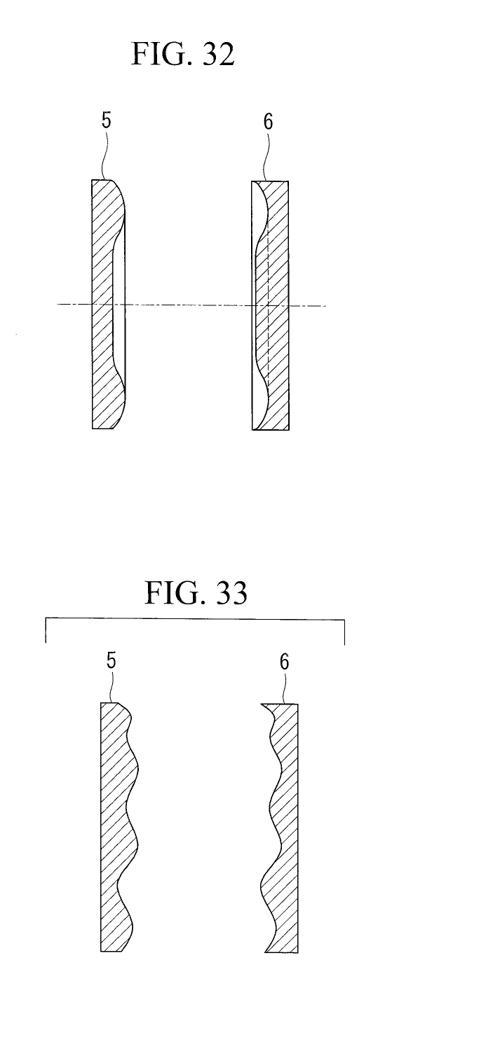

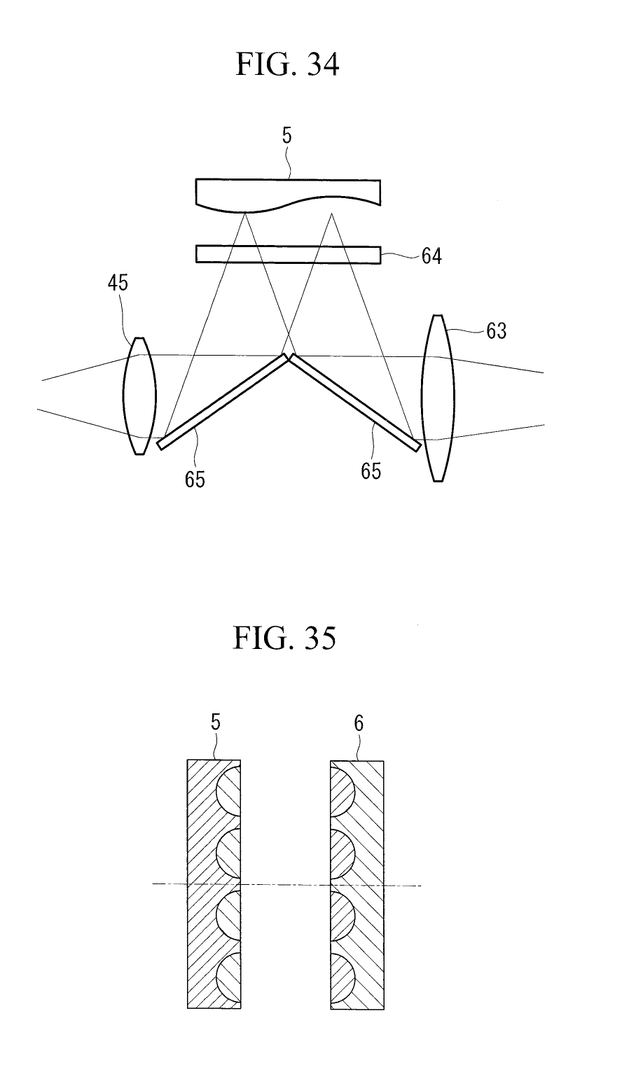

Furthermore, spherical aberration devices as shown in FIG. 32, irregularly-shaped devices as shown in FIG. 33, a reflective wavefront modulation element combined with the transmissive spatial light modulation element 64 as shown in FIG. 34, or gradient-index devices as shown in FIG. 35 may be employed as the phase modulators 5 and 6.

Furthermore, a fly-eye lens or a micro lens array in which many micro lenses are arranged, or alternatively, a micro prism array in which many micro prisms are arranged may be employed as the phase modulators 5 and 6.

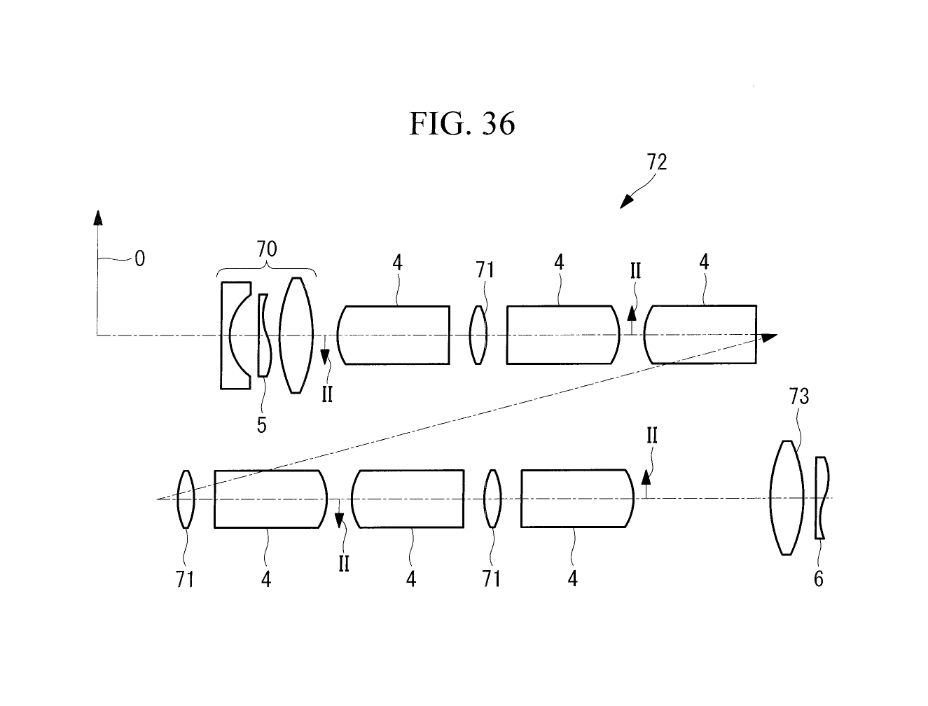

In addition, in a case where the image-forming optical system 1 according to the above-described embodiments is to be applied to an endoscope, it is a good idea to place the phase-disturbing device 5 in an objective lens (image-forming lens) 70 and to place the phase-restoring device 6 in the vicinity of an eyepiece 73 placed on the opposite side of a relay optical system 72, including the plurality of field lenses 4 and a focusing lens 71, from the objective lens 70, as shown in FIG. 36. By doing so, the intermediate images formed in the vicinity of the surfaces of the field lenses 4 can be made unclear, and the final image formed by the eyepiece 73 can be made clear.

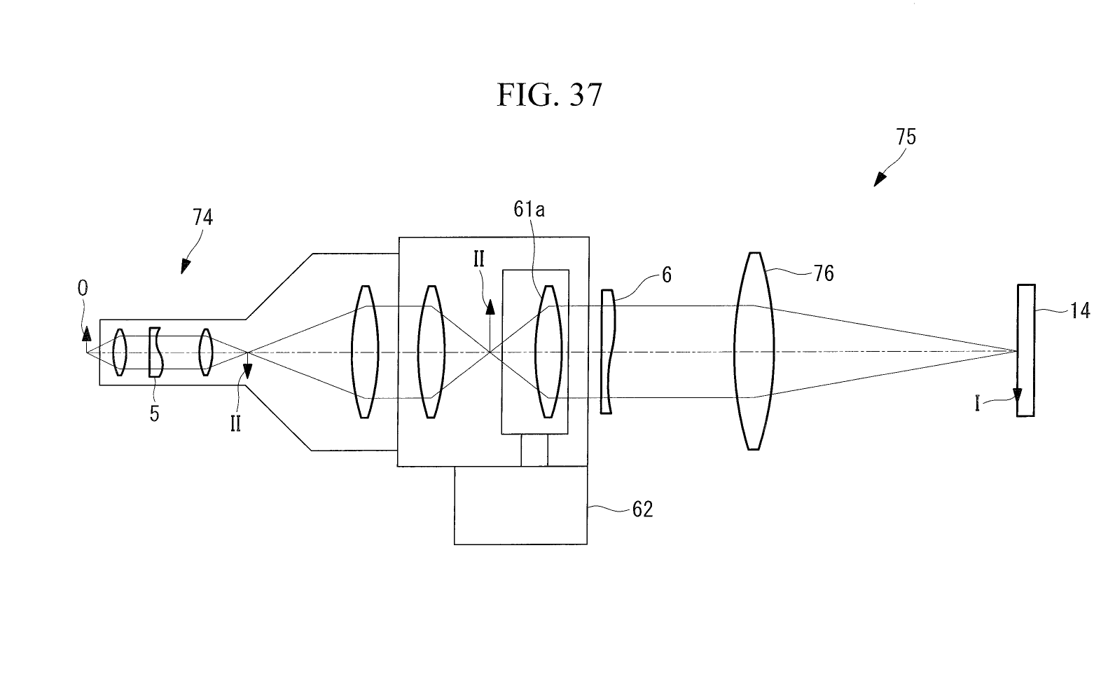

Furthermore, the wavefront-disturbing device 5 may be provided in an endoscope-type small-diameter objective lens having an inner focus function 74 for driving the lens 61a with the actuator 62, and the wavefront-restoring device 6 may be placed in the vicinity of the pupil position of a tube lens (image-forming lens) 76 provided in a microscope main body 75, as shown in FIG. 37. As described above, although the actuator itself may be a well-known lens driving means (e.g., a piezoelectric element), an arrangement that allows spatial modulation of the intermediate image to be carried out is important in respect of moving the intermediate image on the Z axis from the same viewpoint as in the above-described embodiment.

The embodiments described above have discussed a case where an intermediate image that is made unclear through spatial modulation is applied to an image-forming optical system of an observation apparatus, in respect of moving the intermediate image on the Z axis. This can also be applied to an observation apparatus in the same manner in another respect of moving an intermediate image on the XY axes (or XY plane).

The above-discussed image-forming optical system of the present invention can have the following aspects, and on the basis of the spirit indicated below, persons of ordinary skill in the art can examine those aspects for optimal embodiments. Because the following aspects provide an image-forming optical system that is characterized by having a structure for adjusting or increasing spatial disturbance and canceling out that disturbance in the above-described (one pair of) phase modulators, original operating effects can be further advanced or practical advantages can be produced on the basis of the phase modulator of the present invention.

### (1) Periodic Unevenness Structured Phase Modulator

For example, the first phase modulator for making images unclear and the second phase modulator for demodulation may be an image-forming optical system characterized in that the modulation distribution of areas exhibiting a phase lead relative to the mean value of the phase modulation distribution and the modulation distribution of areas exhibiting phase lag relative to the same mean value have shapes symmetrical with respect to the mean value, and in that a plurality of the pairs of the phase lead and phase lag areas are formed so as to have a periodic property. In this manner, by using two phase modulators having the same shape and properly arranging them in an optical system, the intermediate image can be made unclear through complementary phase modulations, namely the first phase modulator, and the final image can be made clear through the second phase modulator, thus making it possible to solve the problem with the intermediate image. In this case, because two different types of phase modulators are not required in order to achieve complementary characteristics but only one type is sufficient, the device can be manufactured more easily and the cost can be reduced.

Furthermore, the above-described first and second phase modulators can be made to have a surface shape (e g., shape composed of depressions and projections is periodically arranged) of an optical medium to carry out phase modulation. By doing so, a necessary phase modulator can be manufactured by the same method as for manufacturing a general phase filter. In addition, the above-described first and second phase modulators may carry out phase modulation through the shapes of the interfaces of a plurality of optical media. By doing so, more accurate phase modulation can be carried out with the same shape accuracy of the optical medium. Alternatively, a phase modulator can be manufactured with a less accurate shape of the optical medium, namely, at lower cost, for the same level of phase modulation accuracy. In addition, the above-described first and second phase modulators may have one-dimensional phase distribution characteristics. By doing so, the intermediate image can be made unclear effectively. In addition, the above-described first and second phase modulators may have two-dimensional phase distribution characteristics. By doing so, the intermediate image can be made unclear effectively.

### (2) Liquid-Crystal Phase Modulator

Furthermore, the above-described first and second phase modulators may constitute an image-forming optical system so as to have liquid crystal sandwiched between a plurality of substrates. By doing so, the intermediate image can be made unclear by splitting, into a plurality of focusing points, one focusing point in the intermediate image via the first phase modulator on the basis of the birefringence of the liquid crystal, and furthermore, the final image can be made clear by restoring the split focusing points into one point via the second phase modulator, thereby making it possible to solve the problem with the intermediate image. In this case, compared with other birefringent materials, for example, crystal formed of an inorganic material like quartz crystal, the liquid crystal serving as a birefringent material is advantageous in that there are so many types available that design is possible with a high degree of freedom, and also in that the birefringence effect is so intense that the intermediate image can be made unclear more effectively.

Furthermore, if the substrate surface in contact with the liquid crystal is a flat surface, the liquid crystal sandwiched between the flat surfaces exhibits the above-described effect of making images unclear as a birefringent prism. In this case, because the surfaces of the substrates sandwiching the liquid crystal are flat surfaces, an advantage is afforded in that processing of the substrates is easier. Furthermore, each of the above-described first and second phase modulators may be composed of a plurality of prisms formed of liquid crystal.

In this case, each time one prism is added, the number of focusing points in the intermediate image is doubled, causing the intermediate image to be split into more focusing points and thereby increasing the effect of making the intermediate image unclear. In addition, each of the above-described first and second phase modulators may have at least one quarter-wave plate. In this case, as a result of the quarter-wave plate being used, a high degree of freedom in arranging split focusing points on the intermediate image is ensured. For example, this is preferable in that focusing points split by a plurality of prisms into, for example, four points or eight points can be arranged on a straight line.

In addition, this is preferable in that if the intermediate image points split by the above-described birefringence form an image-forming optical system arranged two-dimensionally, the intermediate image can be made unclear effectively.

In addition, the phase modulators may be made so that the substrate surface in contact with the liquid crystal has an uneven shape (concave surface, convex surface, concave/convex surface, or non-planar surface). With this structure, the effect of making the intermediate image unclear, intrinsic to an uneven shape (cylindrical surface, toric surface, lenticular surface, micro lens array shape, random surface, and so forth), can be further enhanced through birefringence of the liquid crystal. Alternatively, the above-described first and second phase modulators may be designed so that the uneven shapes of the substrates therein are complementary and so that the orientations (directions) of the liquid crystals therein are parallel. According to this design, the phase modulations of the two phase modulators can be made to have complementary characteristics, namely, allowing the ultimate image (final image) to be restored. Alternatively, the above-described first and second phase modulators may be configured so that the uneven shapes of the substrates therein are the same, so that the refractive indices of the glass members constituting the substrates are equal to the mean value of the two main refractive indices of the above-described liquid crystals, and so that the orientations (directions) of the liquid crystals therein are orthogonal. Also by doing this, the phase modulations in the two phase modulators can be made to have complementary characteristics; namely, the final image can be restored.

### (3) Different Multi-Media Phase Modulator

The above-described image-forming optical system may be configured so that the shape of the boundary surface of a plurality of types of optical media functions as phase modulation means. In this case, larger permissible values for dimensional errors are allowed, compared with a normal phase element (the shape of the interface with the air is made to function as phase modulation means). Because of this, not only does manufacturing become easy but also phase modulation can be carried out more accurately with the same dimensional errors. In this case, both the first phase modulator and the second phase modulator may be configured so as to come into contact with each other to serve as a plurality of types of optical media having refractive indices different from each other. By making both the phase modulators a multi-media type, manufacturing becomes much easier, and phase modulation can be made more accurate.

In addition, a first optical medium section constituting the first phase modulator and a second optical medium section constituting the second phase modulator may have the same shape, the second optical medium and a third optical medium that is brought into contact with the first optical medium may have the same refractive index, and the first optical medium and a fourth optical medium that is brought into contact with the second optical medium may have the same refractive index. By doing so, a pair of optical media having a common refractive index can be used for each of the first and second phase modulators, so that they have complementary phase modulation characteristics by replacing only the shape relationships. In this case, because the shapes of the interfaces between the optical media in the phase modulators are the same, the two phase modulators can be arranged in an optically conjugate manner, including the viewpoint of the three-dimensional interface shape, when they are arranged in an optical system, and therefore, the operation of the second phase modulator to cancel out the wavefront disturbance (make the image clear) becomes more accurate. In addition, by making not only the refractive indices but also the optical media themselves common, even if the refractive indices of optical media have variations for each production lot, for example, or an environmental effect or a time-lapse change occurs, a shift in phase modulation resulting from them is cancelled out between the two phase modulators themselves. Thus, the operation of making the image clear can be carried out more accurately by the second phase modulator.

In addition, the image-forming optical system may be configured such that the first optical medium section constituting the first phase modulator and the second optical medium section constituting the second phase modulator have the same shape and the same refractive index and such that Δn1 and Δn2 have the same absolute value and opposite signs, where Δn1 is the difference from the refractive index of the third optical medium that is brought into contact with the first optical medium to the refractive index of the first optical medium and Δn2 is the difference from the refractive index of the fourth optical medium that is brought into contact with the second optical medium to the refractive index of the second optical medium. For this purpose, it is s good idea that phase elements having the same shape and the same refractive index are used in common for one of a plurality of optical medium sections constituting each of the first and second phase modulators. For this common refractive index, it is also a good idea to use a pair of optical media having higher refractive index for one phase modulator, and to use a pair of optical media having lower refractive index for the other phase modulator. By making the absolute values of the differences between refractive indices in the pairs equal, it is possible to assign complementary phase modulation characteristics. In this case, because the interface shapes in the phase modulators become the same in the same manner as described above, the image is made clear more accurately by the second phase modulator when the two phase modulators are arranged in a conjugate manner. Furthermore, by making common not only the shapes and the refractive indices but also the optical elements themselves in the above-described common section, the cost of the phase modulators, which have a completed shape and are difficult to manufacture, can be reduced. Furthermore, in a case where this optical element is to be manufactured by molding using, for example, a die, even if an unexpected shape error occurs due to a defect in the die, the error in phase modulation resulting from the shape error in the first phase modulator can be cancelled out by the commonly existing shape error in the second phase modulator placed at the conjugate position because the optical elements share the same shape error. More specifically, the operation of the second phase modulator to cancel out the wavefront disturbance (make the image clear) is carried out more accurately.

### (4) Birefringent Phase Modulator

Furthermore, the above-described image-forming optical system may be configured so that the first and second phase modulators are prisms each made of a birefringent medium. With this structure, after a pair of birefringent prisms that are made of the same material and that have the same shape are appropriately arranged in an optical system, an intermediate image is made unclear by splitting, into a plurality of focusing points, one focusing point in the intermediate image via the first prism, namely, the first phase modulator, and thereafter, the above-described split focusing points are overlapped to recover one focusing point via the second prism, namely, the second phase modulator to make the final image clear, thus solving the problem with the intermediate image. In this case, because the phase modulators can be configured from a combination of only components whose materials are polished to flat surfaces, a complicated surface shape is not required, unlike, for example, a micro lens array and a lenticular, thus making it easier to manufacture a device at lower cost.

In addition, each of the first and the second phase modulators may be configured of a plurality of prisms each made of a birefringent medium. In this case, each time one prism is added, the number of focusing points in the intermediate image is doubled, causing one focusing point to be split into more focusing points. This means that the effect of making the intermediate image unclear is enhanced. Alternatively, each of the first and the second phase modulators may have at least one quarter-wave plate. With a quarter-wave plate, the split focusing points are placed on the intermediate image more freely, and a focusing point split by a plurality of prisms into, for example, four points or eight points can be arranged on a straight line. In addition, the configuration may be such that the intermediate image points split by birefringence are arranged two dimensionally. By doing so, the intermediate image can be made unclear effectively.

Although the embodiments of the present invention have been described in detail with reference to the drawings, the specific structure is not limited to those of these embodiments but includes design changes etc. that do not depart from the spirit of the present invention. The present invention is not limited to the invention applied to each of the above-described embodiments and their modifications but can be applied to, for example, embodiments in which these embodiments and modifications are appropriately combined and is not particularly limited.

The aforementioned embodiments are included in the following aspects of the invention.

One aspect of the present invention is an image-forming optical system including: a plurality of image-forming lenses that form a final image and at least one intermediate image; a first phase modulator that is placed at an observation subject side relative to one of the intermediate images formed by the image-forming lenses and that imparts a spatial disturbance to a wavefront of light from the object; and a second phase modulator that is placed at a position so that at least one intermediate image is located between the position and the first phase modulator, and that cancels out the spatial disturbance imparted by the first phase modulator to the wavefront of the light from the object, wherein the image-forming optical system has an image formation property which maintains conjugacy in an image formation relationship between the first and second phase modulators. In this aspect, the structure for maintaining conjugacy in image formation relationship between the first and second phase modulators may be a conjugacy-maintaining optical system placed between the first and second phase modulator.

In this description, two aspects of images are used: one is “clear image” and the other is “unclear image” (or “blurred image”).

First, the term “clear image” indicates an image generated through an image-forming lens in a state where no spatial disturbance is imparted to the wavefront of the light emitted from the object or in a state where disturbance once imparted is cancelled out, the “clear image” having a spatial frequency band determined by the light wavelength and the numerical aperture of the image-forming lens, a spatial frequency band similar to it, or a desired spatial frequency band according to the purpose. In addition, the term “unclear image” (or “blurred image”) indicates an image generated through an image-forming lens in a state where a spatial disturbance is imparted to the wavefront of the light emitted from the object, the “unclear image” having characteristics for substantially preventing a flaw, foreign object, defect, and so forth present on the surface of or in an optical element placed in the vicinity of the image from being formed as the final image.

Unlike just an out-of-focus image, the “unclear image” (or “blurred image”) formed in this manner, including the image at the position at which the image should in fact be formed (i.e., the image forming position as if no spatial disturbance is imparted to the wavefront), does not have a distinct peak in image contrast over a wide area along the optical axis direction. The “unclear image” always exhibits a narrow spatial frequency band, compared with the spatial frequency band of the “clear image.”

The “clear image” and “unclear image” (or “blurred image”) as used in this description are based on the concept described above, and the movement of the intermediate images on the Z-axis as applied in the present invention means the movement of the intermediate images while they are being blurred. Furthermore, Z-axis scanning is not limited to the movement of light on the Z-axis but may be accompanied with the movement of light on XY, as described below.

According to this aspect, the light entering from the observation subject side of the image-forming lenses is focused by the image-forming lenses, thereby forming the final image. In this case, a spatial disturbance is imparted to the wavefront of the light through the first phase modulator placed at the observation subject side relative to one of the intermediate images, thereby causing the intermediate images to be blurred. In addition, as a result of the light that has formed the intermediate images passing through the second phase modulator, the wavefront spatial disturbance imparted by the first phase modulator is canceled out. Because of this, the final image that is formed in the sections subsequent to the second phase modulator becomes clear. In particular, for the light passing through the image-forming optical system with a scanning system, the intermediate image moves on the Z axis while maintaining the above-described spatial modulation and also passes through each lens of the image-forming optical system while being blurred during Z-axis scanning.

In other words, as a result of the intermediate images being blurred, even if some optical element is placed in the intermediate-image position and a flaw, foreign object, defect, and so forth are present on the surface of or in the optical element, it is possible to prevent the occurrence of a disadvantage that the flaw, foreign object, defect, and so forth of the optical element overlap the intermediate images, eventually forming a part of the final image. Furthermore, when applied to a microscope optical system, even if the intermediate image made to move on the Z axis by, for example, focusing overlaps a lens located before or after the intermediate image, no noise images, such as images showing a flaw or foreign object on the surface of the lens, a defect in the lens, and so forth, occur on the final image.

Here, the present invention focuses on a pupil aberration and provide a description that we stand on the base that it is important to set preferable conditions for conjugacy in pupil image formation. More specifically, a first viewpoint includes a configuration for enhancing the performance and approaching the optical ideal by conforming to the sine condition. In more detail, a distortion aberration appropriate for object image formation with a pupil relaying lens (conjugacy-maintaining optical system) is given and the sine condition for pupil image formation is satisfied so that the image of one phase modulator is projected onto the other phase modulator with a high image formation performance (these conditions are referred to as “ensuring pupil conjugacy” here). The operational advantages of this viewpoint include capability of preventing a pupil aberration, which ensures a “pupil conjugate relationship” through pupil image formation, and thereby employing a phase modulator having a high effect of blurring (making unclear) an intermediate image. Although satisfying the sine condition in pupil image formation means correction of a spherical aberration and a comatic aberration in pupil image formation, it is preferable that other aberrations in pupil image formation, namely an axial chromatic aberration, a chromatic aberration of magnification, a distortion aberration, an astigmatism, and an image plane curvature, be also corrected from the viewpoint of “ensuring pupil conjugacy”.

A second viewpoint, which deviates from the sine condition though, includes employing a “general lens” as a pupil relaying lens, taking into account performance limitations of an optical system. In this case, any problem of not satisfying the sine condition for pupil image formation is addressed with a realistic and quickly feasible solution by applying conditions for suppressing an adverse effect due to a pupil aberration (imperfect “pupil conjugacy”) at a practically sufficient level. More specifically, the upper limit of a change in the slope of a ray resulting from phase conditions, serving as a practically permissible amount of a pupil aberration, is obtained. The operational advantages of this viewpoint include a reduction in the cost of the pupil relaying lens. This affords an advantage in that a sufficient “pupil conjugate relationship” can be ensured even with “imperfect” pupil image formation suffering from an aberration.

Note that the phase modulators in the present invention are not necessarily placed on a pupil plane or a pupil conjugate plane (accurately, the advantage is produced by placing them at a position other than an image plane and an intermediate-image plane). Therefore, the positional relationship when the image of one phase modulator is projected on the other phase modulator does not always coincides with a pupil conjugated positional relationship. For the sake of simple expression, however, the positional relationship, as interpreted by the above-described meaning, between the phase modulators, is broadly referred to as “pupil conjugacy,” even if the phase modulators are placed at positions other than a pupil plane or a pupil conjugate plane.

In the above-described aspect, the first phase modulator and the second phase modulator may be placed at vicinities of pupil positions of the image-forming lenses.

By doing so, the first phase modulator and the second phase modulator can be made compact as a result of being placed in the vicinities of the pupil positions free of variations in light beam.

In addition, in the above-described aspect, an optical-path-length changing unit may be employed, which is capable of changing an optical-path length between two of the image-forming lenses placed at positions between which one of the intermediate images may be located.

By doing so, the image-forming position of the final image can be changed easily in the optical axis direction by changing the optical-path length between the two image-forming lenses through the operation of the optical-path-length changing unit.

Furthermore, in the above-described aspect, the optical-path-length changing unit may be provided with: a plane mirror that is placed to be orthogonal to an optical axis and that reflects light forming the intermediate images; an actuator for moving the plane mirror in an optical axis direction; and a beam splitter for splitting into two directions the light reflected by the plane mirror.

By doing so, the light from the observation subject side focused by the image-forming lens on the observation subject side is reflected at the plane mirror, split off by the beam splitter, and enters the image-forming lens on the image side. In this case, the optical-path length between the two image-forming lenses can easily be changed by operating the actuator to move the plane mirror in the optical axis direction, thereby allowing the image-forming position of the final image to be easily changed in the optical axis direction.

Also in the above-described aspect, a variable spatial phase modulator provided at a vicinity of a pupil position of one of the image-forming lenses, for changing a position of the final image in an optical axis direction by changing a spatial phase modulation to be imparted to the wavefront of the light may be employed.

By doing so, spatial phase modulation that changes the position of the final image in the optical axis direction can be imparted to the wavefront of the light with the variable spatial phase modulator, and therefore, the image-forming position of the final image can easily be changed in the optical axis direction by adjusting the phase modulation to be imparted.

Furthermore, in the above-described aspect, a function of at least one of the first phase modulator and the second phase modulator may be performed by the variable spatial phase modulator.

By doing so, the variable spatial phase modulator can have both the spatial phase modulation that changes the position of the final image in the optical axis direction and the phase modulation for blurring the intermediate images or the phase modulation for canceling out the blurring of the intermediate images. By doing so, the number of component parts can be reduced, thereby making it possible to configure a simple image-forming optical system.

Furthermore, in the above-described aspect, the first phase modulator and the second phase modulator may impart to the wavefront of the light a phase modulation that changes in a one-dimensional direction orthogonal to an optical axis.

By doing so, the intermediate images can be made to blur by using the first phase modulator to impart, to the wavefront of the light, a phase modulation that changes in the one-dimensional direction orthogonal to the optical axis, and therefore, even if some optical element is placed in the intermediate-image position and a flaw, foreign object, defect, and so forth are present on the surface of or in the optical element, it is possible to prevent the occurrence of a disadvantage in that the flaw, foreign object, defect, and so forth of the optical element overlap the intermediate images, eventually forming a part of the final image. In addition, a clear final image, free of blurring, can be formed by using the second phase modulator to impart to the wavefront of the light a phase modulation for canceling out the phase modulation that has changed in the one-dimensional direction.

Furthermore, in the above-described aspect, the first phase modulator and the second phase modulator may impart to the wavefront of a light beam a phase modulation that changes in two-dimensional directions orthogonal to an optical axis.

By doing so, the intermediate images can be made to blur more reliably by using the first phase modulator to impart to the wavefront of the light a phase modulation that changes in the two-dimensional directions orthogonal to the optical axis. In addition, a clearer final image can be formed by using the second phase modulator to impart to the wavefront of the light a phase modulation for canceling out the phase modulation that has changed in the two-dimensional directions.

Furthermore, in the above-described aspect, the first phase modulator and the second phase modulator may be transmissive elements each of which imparts a phase modulation to the wavefront when transmitting the light.

In addition, in the above-described aspect, the first phase modulator and the second phase modulator may be reflective elements each of which imparts a phase modulation to the wavefront when reflecting the light.

In addition, in the above-described aspect, the first phase modulator and the second phase modulator may have complementary shapes.

By doing so, the first phase modulator that imparts to the wavefront a spatial disturbance for blurring the intermediate images and the second phase modulator that imparts a phase modulation for canceling out the spatial disturbance imparted to the wavefront can be easily configured.

Furthermore, in the above-described aspect, the first phase modulator and the second phase modulator may impart the phase modulation to the wavefront by means of a refractive index profile of a transparent material.

By doing so, a wavefront disturbance in accordance with the refractive index profile can be produced when light passes through the first phase modulator, and a phase modulation that cancels out the wavefront disturbance in accordance with the refractive index profile can be imparted to the wavefront of the light when the light passes through the second phase modulator.

Furthermore, another aspect of the present invention is an illumination apparatus including: one of the above-described image-forming optical systems; and a light source that is disposed at the object side of the image-forming optical system and that generates illumination light entering the image-forming optical system.

According to this aspect, when the illumination light emitted from the light source placed at the observation subject side enters the image-forming optical system, the illumination object placed on the final image side can be irradiated with the illumination light. In this case, the intermediate images formed by the image-forming optical system are blurred through the first phase modulator, and therefore, even if some optical element is placed in the intermediate-image position and a flaw, foreign object, defect, and so forth are present on the surface of or in the optical element, it is possible to prevent the occurrence of a disadvantage in that the flaw, foreign object, defect, and so forth of the optical element overlap the intermediate image, eventually forming a part of the final image.

Furthermore, another aspect of the present invention is an observation apparatus including: one of the above-described image-forming optical systems; and a photo-detector that is disposed at a final image side of the image-forming optical system and that detects light emitted from an observation subject.

According to this aspect, it is possible to detect with the photo-detector a clear final image that has been formed by the image-forming optical system that prevents the image of a flaw, foreign object, defect, and so forth present on the surface of or in the optical element from overlapping the intermediate images.

In the above-described aspect, the photo-detector may be an image-capturing element that is placed at the position of the final image of the image-forming optical system and that acquires the final image.

By doing so, a clear final image can be acquired with the image-capturing element placed at the position of the final image of the image-forming optical system, thereby allowing observation with high accuracy.

Furthermore, another aspect of the present invention is an observation apparatus including: one of the above-described image-forming optical systems; a light source that is disposed at the object side of the image-forming optical system and that generates illumination light entering into the image-forming optical system; and a photo-detector that is disposed at a final image side of the image-forming optical system and that detects light emitted from an observation subject.

According to this aspect, the light from the light source is focused by the image-forming optical system and irradiated on the observation subject, and the light generated on the observation subject is detected by the photo-detector disposed at the final image side. By doing so, it is possible to detect with the photo-detector a clear final image that has been formed by preventing the image of a flaw, foreign object, defect, and so forth present on the surface of or in the intermediate optical element from overlapping the intermediate images.

In the above-described aspect, a Nipkow disk confocal optical system that is disposed between the light source and the image-forming optical system and between the photo detector and the image-forming optical system may be provided.

By doing so, the observation subject can be scanned with multi-point spotlight, thereby allowing a sharp image of the observation subject to be acquired at high speed.

Furthermore, in the above-described aspect, the light source may be a laser light source, and the photo-detector may include a confocal pinhole and a photoelectric conversion element.

By doing so, the observation subject can be observed by means of a clear confocal image without forming the image of a flaw, foreign object, defect, and so forth at the intermediate-image position.

Furthermore, another aspect of the present invention is an observation apparatus including: the above-described illumination apparatus and a photo-detector for detecting light emitted from an observation subject illuminated by the illumination apparatus, wherein the light source is a pulsed laser light source.

By doing so, the observation subject can be observed by means of a clear multiphoton-excitation image without forming the image of a flaw, foreign object, defect, and so forth at the intermediate-image position.

The aforementioned aspects afford an advantage in that, even if the intermediate image is formed at the position coinciding with an optical element, a clear final image can be acquired by preventing a flaw, foreign object, defect, and so forth on the optical element from overlapping the intermediate image, and furthermore, a clearer final image can be acquired by improving the phase modulators.

### REFERENCE SIGNS LIST

I Final image
II Intermediate image
O Object
PP_{O}, PP_{I} Pupil position
1, 13, 32, 42 Image-forming optical system
2, 3 Image-forming lens
5 Wavefront-disturbing device (first phase modulator)
6 Wavefront-restoring device (second phase modulator)
10, 30, 40, 50, 60 Observation apparatus
11, 31, 41 Light source
14, 33 Image-capturing element (photo-detector)
17, 23 Phase modulator
20, 36 Beam splitter
22 Optical-path-length changing means
22a Plane mirror
22b Actuator
34 Nipkow disk confocal optical system
43 Confocal pinhole
44 Photo-detector (photoelectric conversion element)
61a Lens (optical-path-length changing means)
62 Actuator (optical-path-length changing means)
64 Spatial light modulation element (variable spatial phase modulator)
83a and 83b Aspheric lens (conjugacy-maintaining optical system)
85a, 85b, 85c, 85d, 85e, 85f Lens (conjugacy-maintaining optical system)
87a, 91a, 95a First lens group (conjugacy-maintaining optical system)
87b, 91b, 95b Second lens group (conjugacy-maintaining optical system)
93a, 93c Biconvex lens (conjugacy-maintaining optical system)
93b Biconcave lens (conjugacy-maintaining optical system)
95c Third lens group (conjugacy-maintaining optical system)

1. An image-forming optical system comprising:
a plurality of image-forming lenses that form a final image and at least one intermediate image;
a first phase modulator that is placed at an observation subject side relative to one of the intermediate images formed by the image-forming lenses and that imparts a spatial disturbance to a wavefront of light from the observation subject; and
a second phase modulator that is placed at a position so that at least one intermediate image is located between the position and the first phase modulator, and that cancels out the spatial disturbance imparted by the first phase modulator to the wavefront of the light from the observation subject,
wherein the image-forming optical system has an image formation property which maintains conjugacy in an image formation relationship between the first and second phase modulators.

2. The image-forming optical system according to claim 1, wherein a structure for maintaining conjugacy in the image formation relationship between the first and second phase modulators is a conjugacy-maintaining optical system provided between the first and second phase modulators.

3. The image-forming optical system according to claim 1, wherein the first phase modulator and the second phase modulator are placed at vicinities of pupil positions of the image-forming lenses.

4. The image-forming optical system according to claim 1, further comprising an optical-path-length changing unit capable of changing an optical-path length between two of the image-forming lenses placed at positions between which one of the intermediate images is located.

5. The image-forming optical system according to claim 4, wherein the optical-path-length changing unit includes: a plane mirror that is placed to be orthogonal to an optical axis and that reflects light forming the intermediate images; an actuator for moving the plane mirror in an optical axis direction; and a beam splitter for splitting into two directions the light reflected by the plane mirror.

6. The image-forming optical system according to claim 1, further comprising a variable spatial phase modulator provided at a vicinity of a pupil position of one of the image-forming lenses, for changing a position of the final image in an optical axis direction by changing a spatial phase modulation to be imparted to the wavefront of the light.

7. The image-forming optical system according to claim 6, wherein a function of at least one of the first phase modulator and the second phase modulator is performed by the variable spatial phase modulator.

8. The image-forming optical system according to claim 1, wherein the first phase modulator and the second phase modulator impart to the wavefront of a light beam a phase modulation that changes in a one-dimensional direction orthogonal to an optical axis.

9. The image-forming optical system according to claim 1, wherein the first phase modulator and the second phase modulator impart to the wavefront of a light beam a phase modulation that changes in two-dimensional directions orthogonal to an optical axis.

10. The image-forming optical system according to claim 1, wherein the first phase modulator and the second phase modulator are transmissive elements each of which imparts a phase modulation to the wavefront when transmitting the light.

11. The image-forming optical system according to claim 1, wherein the first phase modulator and the second phase modulator are reflective elements each of which imparts a phase modulation to the wavefront when reflecting the light.

12. The image-forming optical system according to claim 1, wherein the first phase modulator and the second phase modulator have complementary shapes.

13. The image-forming optical system according to claim 10, wherein the first phase modulator and the second phase modulator impart the phase modulation to the wavefront by means of a refractive index profile of a transparent material.

14. An illumination apparatus comprising:
the image-forming optical system according to claim 1; and
a light source that is disposed at the object side of the image-forming optical system and that generates illumination light entering the image-forming optical system.

15. An observation apparatus comprising:
the image-forming optical system according to claim 1; and
a photo-detector that is disposed at a final image side of the image-forming optical system and that detects light emitted from an observation subject.

16. The observation apparatus according to claim 15, wherein the photo-detector is an image-capturing element that is placed at a position of the final image of the image-forming optical system and that acquires the final image.

17. An observation apparatus comprising:
the image-forming optical system according to claim 1;
a light source that is disposed at the object side of the image-forming optical system and that generates illumination light entering into the image-forming optical system; and
a photo-detector that is disposed at a final image side of the image-forming optical system and that detects light emitted from an observation subject.

18. The observation apparatus according to claim 17, further comprising a Nipkow disk confocal optical system that is disposed between the light source and the image-forming optical system and between the photo detector and the image-forming optical system.

19. The observation apparatus according to claim 17,
wherein the light source is a laser light source, and
the photo-detector includes a confocal pinhole and a photoelectric conversion element.

20. An observation apparatus comprising:
the illumination apparatus according to claim 14; and
a photo-detector for detecting light emitted from an observation subject illuminated by the illumination apparatus,
wherein the light source is a pulsed laser light source.
